(19) United States
(12) Patent Application Publication
(10) Pub. No.: US 2024/0221046 A1
(43) Pub. Date: Jul. 4, 2024

(54) SYSTEM AND METHOD FOR OPTIMIZING SEARCH SPACE

(71) Applicant: CARBEEZA INC., Edmonton (CA)

(72) Inventors: Sandro Antoni TORRIERI, Edmonton (CA); Nicholas Joseph SAMAHA, Edmonton (CA); Glyn Devin READE, Edmonton (CA); Michael James Wilhelm DUNHAM, Edmonton (CA)

(21) Appl. No.: 18/400,806

(22) Filed: Dec. 29, 2023

Related U.S. Application Data
(60) Provisional application No. 63/436,036, filed on Dec. 29, 2022.

(51) Int. Cl. G06Q 30/0601; G06Q 40/03

(52) U.S. Cl. CPC G06Q 30/0623; G06Q 40/03

(57) ABSTRACT

Systems and methods for search space optimization are provided. The method may include: computing a plurality of first data structures, each representative of wholesale pricing terms for each vehicle in a plurality of vehicles based on information from a plurality of sources; computing a plurality of second data structures, each representative of an approximate deal structure for each vehicle in the plurality of vehicles; computing a plurality of customer tiers, with each customer tier associated with a lender and a likelihood of approval by the lender; generating a reduced set of data structures from the plurality of second data structures based at least on the second data structures and the plurality of customer tiers; generating a plurality of third data structures further reduced from the reduced set of data structures; and computing financing terms for one or more vehicles from the reduced vehicle list based on customer selection.

### CROSS-REFERENCE TO RELATED APPLICATION

The present application claims priority to and benefit of U.S. provisional patent application No. 63/436,036 filed Dec. 29, 2022, the entire content of which is herein incorporated by reference.

### FIELD

The present disclosure generally relates to the field of computer processing and search optimization.

### BACKGROUND

In the automotive inventory space, different components include inventory management, lead and customer management, generating sales proposals with financing options for customers, and finance. While the intersection of these areas is straightforward for customers with good credit, often referred to as prime customers, the process is complex when it comes to customers with poor or bad credit, often referred to as non-prime customers. Consequently, deals for non-prime customers are driven largely by intuition and guesswork, and as a result lenders incur more risk, both dealerships and customers are saddled with suboptimal deals, and dealerships and wholesalers hold onto stock that is not suited to their customer base.

It is desired to fill this gap by improving the customer-retailer-lender triangle in both non-prime and prime retail sales, and by providing dealerships and wholesalers the tools to better manage their inventory, especially for sales to non-prime customers.

Searching through the inventory of a single dealer based on inventory-specific criteria is an example task in providing a user with vehicle information when said user has expressed interest in purchasing a vehicle. Determining likely lender financing terms, for example, monthly payment amount, interest rate, loan term and other loan conditions, for such vehicles for customers of good credit standing is another example task.

Determining a willing lender and appropriate loan terms for an arbitrary vehicle and a customer with other than a prime credit rating is sufficiently complicated and time consuming that many dealerships do not have in-house staff that can perform such an operation. For those dealerships that can do so, there is typically only one or two sales managers with the know-how, and doing the calculation properly for one potential customer can take time, such that in the time it takes to complete the calculation, the potential customer may have walked away. Consequently, it is common for such sales managers to stop with the first possible match and not try any form of optimization, either for the dealer or for the customer.

### SUMMARY

In accordance with one aspect, there is provided a computer-implemented system for search space optimization, the system comprising: at least one processor; memory in communication with the at least one processor; instructions stored in the memory, which when executed at the at least one processor cause the system to: compute a plurality of first data structures, each representative of wholesale pricing terms for each vehicle in a plurality of vehicles based on information from a plurality of sources; compute a plurality of second data structures, each representative of an approximate deal structure for each vehicle in the plurality of vehicles based on a set of information; compute a plurality of customer tiers; generate a reduced set of data structures from the plurality of second data structures based at least on the plurality of customer tiers; generate a plurality of third data structures further reduced from the reduced set of data structures, each third data structure representing an approximate deal structure for a vehicle in a reduced vehicle list from the plurality of vehicles; and compute financing terms for one or more vehicles from the reduced vehicle list based on customer selection.

In some embodiments, the instructions when executed further cause the system to: normalize the information from the plurality of sources.

In some embodiments, the set of information comprises the wholesale pricing information, a set of customer aggregate types, a set of equity bands, and a retailor profit mandate.

In some embodiments, the plurality of third data are generated based on customer data.

In some embodiments, the customer tier is generated based in part on the customer data.

In some embodiments, the reduced set of data structures from the plurality of second data structures are generated based on trade in values in the customer data.

In some embodiments, the plurality of third data structures is further reduced from the reduced set of data structures based on a customer's credit score.

In some embodiments, the plurality of third data structures is further reduced from the reduced set of data structures based on a customer's equity level.

In some embodiments, each of the plurality of customer tier is associated with a lender.

In some embodiments, each of the plurality of customer tier is associated with a likelihood of approval by the lender.

In accordance with another aspect, there is provided a computer-implemented method for search space optimization, the method comprising: computing a plurality of first data structures, each representative of wholesale pricing terms for each vehicle in a plurality of vehicles based on information from a plurality of sources; computing a plurality of second data structures, each representative of an approximate deal structure for each vehicle in the plurality of vehicles based on a set of information; computing a plurality of customer tiers; generating a reduced set of data structures from the plurality of second data structures based at least on the plurality of customer tiers; generating a plurality of third data structures further reduced from the reduced set of data structures, each third data structure representing an approximate deal structure for a vehicle in a reduced vehicle list from the plurality of vehicles; and computing financing terms for one or more vehicles from the reduced vehicle list based on customer selection.

In some embodiments, the method may include normalizing the information from the plurality of sources.

In some embodiments, the set of information comprises the wholesale pricing information, a set of customer aggregate types, a set of equity bands, and a retailor profit mandate.

In some embodiments, the plurality of third data are generated based on customer data.

In some embodiments, the customer tier is generated based in part on the customer data.

In some embodiments, the reduced set of data structures from the plurality of second data structures are generated based on trade in values in the customer data.

In some embodiments, the plurality of third data structures is further reduced from the reduced set of data structures based on a customer's credit score.

In some embodiments, the plurality of third data structures is further reduced from the reduced set of data structures based on a customer's equity level.

In some embodiments, each of the plurality of customer tier is associated with a lender.

In some embodiments, each of the plurality of customer tier is associated with a likelihood of approval by the lender.

In accordance with one aspect, there is provided a computer-implemented system for search space optimization, the system may include: at least one processor; memory in communication with the at least one processor; instructions stored in the memory, which when executed at the at least one processor cause the system to: compute a plurality of first data structures, each representative of wholesale pricing terms for each vehicle in a plurality of vehicles based on information from a plurality of sources; compute a plurality of second data structures, each representative of an approximate deal structure for each vehicle in the plurality of vehicles based on the wholesale pricing information, a set of customer aggregate types, a set of equity bands, and a retailor profit mandate; compute a plurality of customer tiers, with each customer tier associated with a lender and a likelihood of approval by the lender; generate a reduced set of data structures from the plurality of second data structures based at least on the plurality of customer tiers; generate a plurality of third data structures further reduced from the reduced set of data structures based on customer data, each third data structure representing an approximate deal structure for a vehicle in a reduced vehicle list from the plurality of vehicles; and compute financing terms for one or more vehicles from the reduced vehicle list based on customer selection.

In some embodiments, the instructions when executed further cause the system to: normalize the information from the plurality of sources.

In some embodiments, the customer tier is generated based in part on the customer data.

In some embodiments, the reduced set of data structures from the plurality of second data structures are generated based on trade in values in the customer data.

In some embodiments, the plurality of third data structures is further reduced from the reduced set of data structures based on a customer's credit score or equity level.

In accordance with another aspect, there is provided a computer-implemented method for search space optimization, the method comprising: computing a plurality of first data structures, each representative of wholesale pricing terms for each vehicle in a plurality of vehicles based on information from a plurality of sources; computing a plurality of second data structures, each representative of an approximate deal structure for each vehicle in the plurality of vehicles based on the wholesale pricing information, a set of customer aggregate types, a set of equity bands, and a retailor profit mandate; computing a plurality of customer tiers, with each customer tier associated with a lender and a likelihood of approval by the lender; generating a reduced set of data structures from the plurality of second data structures based at least on the plurality of customer tiers; generating a plurality of third data structures further reduced from the reduced set of data structures based on customer data, each third data structure representing an approximate deal structure for a vehicle in a reduced vehicle list from the plurality of vehicles; and computing financing terms for one or more vehicles from the reduced vehicle list based on customer selection.

In some embodiments, the method may include normalizing the information from the plurality of sources.

In some embodiments, the customer tier is generated based in part on the customer data.

In some embodiments, the reduced set of data structures from the plurality of second data structures are generated based on trade in values in the customer data.

In some embodiments, the plurality of third data structures is further reduced from the reduced set of data structures based on a customer's credit score or equity level.

### BRIEF DESCRIPTION OF THE FIGURES

Embodiments will now be described with reference to the figures, in which like reference characters denote like elements, by way of example, and in which:

FIG. 1 is a diagram showing inputs and outputs for a computer system.

FIG. 2 is a diagram showing elements of an example system spread across multiple economic entities.

FIG. 3 is a flow diagram showing an example method.

FIG. 4 is a schematic diagram showing elements of a computer system.

FIG. 5 shows an example loading screen for an example customer-facing app.

FIG. 6 shows an example initial choice screen for an example customer-facing app.

FIG. 7 shows an example customer parameter entry screen for an example customer-facing app.

FIG. 8 shows an example vehicle filter screen for an example customer facing app.

FIG. 9A shows an example vehicle list screen for an example customer facing app.

FIG. 9B shows two entries from the example vehicle list screen of FIG. 9A.

FIG. 10 shows an example deal prediction screen for an example customer-facing app.

FIG. 11 shows an example information screen for an example customer-facing app.

FIG. 12 shows an example list screen for an example customer-facing app.

FIG. 13 shows an example auction start screen for an example customer-facing app.

FIG. 14 shows an example login/signup screen for an example customer-facing app.

FIG. 15 shows an example auction progress screen for an example customer-facing app.

FIG. 16A shows an example customer dashboard screen for an example customer-facing app.

FIG. 16B shows auction information from the example customer dashboard screen of FIG. 16A.

FIG. 17 shows an example results list screen for an example customer-facing app.

FIG. 18 shows an example results list screen for an example customer-facing app.

FIG. 19 shows an example credit pull authorization screen for an example customer-facing app.

FIG. 20 shows an example success reporting screen for an example customer-facing app.

FIG. 21 shows an example contact information screen for an example customer-facing app.

FIG. 22 shows an example initial screen for an example dealer-facing app.

FIG. 23 shows an example dealership selection screen for an example dealer-facing app.

FIG. 24A shows an example dealer dashboard screen for an example dealer-facing app.

FIG. 24B shows a bid card from the dealer dashboard screen of FIG. 24A.

FIG. 25 shows an example bid request listing screen for an example dealer-facing app.

FIG. 26 shows an example bid request listing screen for an example dealer-facing app.

FIG. 27 shows an example bid creation screen for an example dealer-facing app.

FIG. 28 shows an example VIN entry screen for an example dealer-facing app.

FIG. 29 shows an example configuration screen for an example dealer-facing app.

FIG. 30 shows an example feature selection screen for an example dealer-facing app.

FIG. 31 shows an example confirmation screen for an example dealer-facing app.

FIG. 32 shows an example aftermarket products screen for an example dealer-facing app.

FIG. 33 shows an example deal proposal screen for an example dealer-facing app.

FIG. 34 shows an example bid submission screen for an example dealer-facing app.

FIG. 35 shows an example bid acceptance screen for an example dealer-facing app.

FIG. 36 shows an example customer contact screen for an example dealer-facing app.

FIG. 37 shows an example neural network for tier prediction.

FIG. 38 shows an example neural network for lender approval prediction.

FIG. 39 shows the combination of the neural networks of FIGS. 37 and 38 to use the tier prediction output as input for the lender approval prediction.

FIG. 40 is an example process for generating an optimized vehicle offer, in accordance with one embodiment.

FIG. 41 is a schematic diagram of a computing device that implements a computer system to perform an example process for space search optimization, in accordance with an embodiment.

FIG. 42 is an example flow process for space search optimization, in accordance with an embodiment.

FIG. 43A shows an example Booking Sheet from a Lender for a first group of customers (e.g., non-prime customers).

FIG. 43B shows another example Booking Sheet from the same Lender for a second group of customers (e.g., non-prime customers).

### DETAILED DESCRIPTION

Throughout this disclosure, a dealer or dealership may act as a retailer for new and used vehicles, and the terms “dealer”, “dealership”, and “retailer” may be used in an interchangeable manner to refer to a business entity that sells goods (e.g., vehicles or related goods and services) to the public. A dealer or dealership may be an example of a retailer.

The PoweredByIdeal™ system (herein, “Ideal”) is a set of cooperating engines that facilitate the purchase and funding of large-ticket items. In an example, the items are vehicles, but the items could be other purchases, especially purchases that are likely to be funded through a loan arranged in respect of the particular purchase. An initial implementation in particular focuses on the purchase and funding of vehicles by customers with a wide range of credit worthiness. In this implementation it brings together customers, retailers, wholesalers, lenders, services providers (i.e., inspection, maintenance, repair, detailing, and transportation), and streamlines traditional workflow to minimize guesswork and optimize various aspects of the transaction.

As part of this workflow, Ideal also enhances the audit capabilities of such transactions, such that improved visibility in the process is provided to Responsible Parties (business owners and controlling stakeholders in the process).

In this document, the term inventory and vehicle are used interchangeably. While the concepts apply to large-ticket inventory in general, the initial implementation specifically handles vehicles (including recreational, watercraft, and similar variants).

### Definitions

Responsible Party—A Responsible Party (RP) is the person or organization that has both the vested interest and authority to control key overall behaviors of Ideal, or portions of Ideal. These are typically the respective business owners, lending institutions, and other legal entities. Ideal operates on the principle of providing an RP with the tools to effectively control how their staff and organization operate, including the auditing of key information, while permitting the RP to optimize their business rules to their liking, within the confines of their regulatory frameworks.

Buyer—A person who conducts inventory purchasing for a dealer or wholesaler.

Deal—A completed transaction between a retailer and a customer to sell a specific vehicle, including any ancillary products and services, to a customer at financial terms that have been agreed to by a specific lender.

Specific Vehicle—Within this document, a Specific Vehicle is an instance of a particular physical vehicle.

Representative Vehicle—Within this document, Representative Vehicle identifies a group of vehicles where all vehicles share the same make, model, year, trim, style, and feature set and would be expected to be of approximately the same value excluding variation to do with mileage, condition, and similar wear factors.

Customer Tier—This is a broad categorization of customers that generally identifies how risky it is for Lenders to provide financing for a given customer. Many factors may influence how a Lender arranges its tiers. One example factor is a credit rating of a given customer.

Profit Mandate—This is a set of rules that controls the optimizations that will be conducted for a particular provider, such as a retailer or wholesaler. While profit earned on a specific vehicle is certainly one of the contributing factors, other factors are also considered including but not limited to the desire for return customers and the requirement to move aging stock. This weighting function is under the control of the respective dealership or wholesaler.

Profit Mandate Rating (PMR)—This is a dimensionless aggregate quantity that is used to express the desire, for a given (vehicle) provider, to sell one vehicle compared to another, based on the rules defined in the Profit Mandate. While Ideal does not dictate compensation models for sales staff, it is intended that a compensation model that considers the PMR should result in the interests of sales staff being more aligned with the interests of the dealership than they might be otherwise.

Vehicle Damage Assessment (VDA)—This is an assessment, or the cash value of the assessment, of the outstanding damage on the vehicle that must be repaired before a retail sale can be completed.

Lender Decision Engine (LDE)—This is a subsystem that is used for predicting interactions with lending institutions.

Vehicle Evaluation Engine (V-EVAL)—This is a subsystem that is used to conduct vehicle valuations.

Advertisement—In the context of Ideal, an Advertisement is a notification from an Inventory Holder to either Retailers or other Inventory Holders as to the availability and price of stock that is currently held.

Wholesale Package—This is a collection of vehicles that are being sold as a single unit. A wholesale package always has a price for the entire package. When in a package, vehicles need not be priced individually. When vehicles are individually priced within a package, the sum of all vehicle prices may be higher, the same as, or lower than the package price.

Hold—A Hold is an expression of interest in a vehicle. It comes in two flavours, a Soft Hold and a Hard Hold, which have implications for the vehicle workflow. Hard Holds will often involve a cash deposit by the customer. Soft holds have less formality and may, for example, be arranged verbally or by e-mail. Soft holds may not always be permitted by an Inventory Holder.

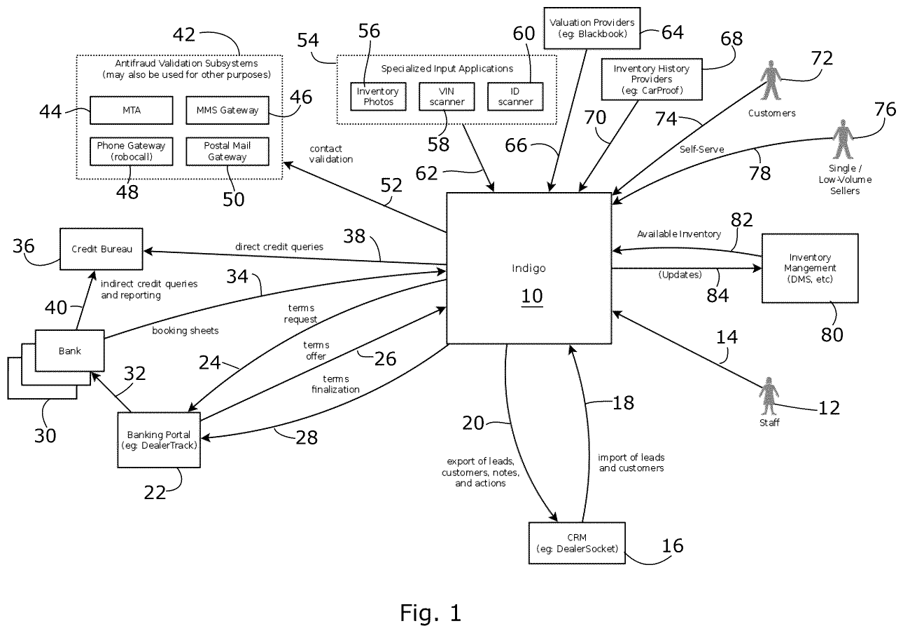

FIG. 1 is a diagram showing context for an example system as described in this document and information flows into and out of the system. As shown in FIG. 1, the system 10 interacts with plural other entities including: dealer staff 12 who may provide staff input 14; customer relationship management software 16 from which leads and customers may be imported in flow 18 and to which leads, customers, notes and actions may be exported in flow 20; a lending portal 22, such as for example DealerTrack™, to which a terms request can be sent in flow 24, from which a terms offer may be received in flow 26, and to which a terms finalization may be sent in flow 28; one or more banks 30, which may receive finance information in flow 32 from the banking (lending) portal 22, which flow may include flows 24-28 as relayed through the banking portal, and from which booking sheets may be received in flow 34; a credit bureau 36, to which credit inquiries may be sent directly by the system in flow 38, or from a bank in flow 40, which flow may also include reporting of credit information by the bank; antifraud validation subsystems 42 such as, for example, MTA 44, Multimedia Messaging Service Gateway 46, Phone Gateway 48, and postal mail gateway 50, which may receive flow 52 from the system 10 for antifraud validation of contact information and may also be used for other purposes; specialized input applications 54, such as inventory photos 56, VIN scanner 58, and ID scanner 60, which may send input to the system 10 in flow 62; valuation providers 64 (e.g., BlackBook™), which may provide valuation information in flow 66; inventory history providers 68, such as CarProof™ which may provide inventory history information in flow 70; customers 72, who may interact with the system 10 in a self-service arrangement via flow 74; single or low-volume sellers 76, who may interact with the system 10 in flow 78; and inventory management software 80, which may send information on available inventory in flow 82, and receive updates from the system 10 in flow 84. Not all flows and entities need be present in all embodiments and other flows and entities may also be present.

Stakeholders—The visible functions of Ideal differ depending on the perspective of the user. A brief list of the primary system stakeholders is included below. A given (real) organization may act as more than one stakeholder type; however, a stakeholder type may be considered in isolation and then optimized for the cases where an organization acts as more than one stakeholder.

Inventory Holder—This is any stakeholder which has inventory (here, vehicles) that they wish to sell. The typical Inventory Holders are either vehicle wholesalers or the inventory management group of retail dealers.

Retailer—This is a stakeholder that is primarily involved in orchestrating a retail Deal so as to marry up a customer with an appropriate vehicle and funding. As a side effect of this process, the Retailer will also orchestrate (but not necessarily perform) operations required to finalize the deal including arranging servicing, repair, detailing, and transportation involving the vehicle.

Customer—The customer is the stakeholder who intends to purchase a vehicle. This includes both individuals and organizations in personal and commercial transactions.

Lender—Lenders are those organizations (banks or other lending institutions) which provide financing for the Deal.

Services Provider—Services Providers are responsible for the completion of tasks associated with supporting vehicle sales (pre-sale or post-sale, retail or wholesale). They may either be closely related to, part of, or at arms' length from, a Retailer. They interact with Retailers and Inventory Holders through a service order model that allows a Retailer or Inventory Holder to delegate tasks to one or more Services Provider. The services in question include tasks such as inspection, maintenance, repair, detailing, and transportation of vehicles.

Root Provider—Within the system, there is exactly one (logical) Root Provider. This is the presence of Ideal Corporate. The Root Provider is responsible for the provisioning and deprovisioning of stakeholder organizations, coordination of key system parameters between other providers, collection of any metrics with associated system operation, collection/analysis/synthesis of data corresponding to inter-provider metrics/trends/predictions. In practice, the Root Provider may be implemented through a set of cooperating systems. A high-level description of the functions observed by each stakeholder is described below.

### Provider Function Overview

Ideal is structured around the concept of a federation of interacting autonomous Providers, where each Provider is optimized to best service its user base. For example, even though various aggregate metrics are shared throughout the system, a Retail Provider will try to optimize its own deals according to the specifics of that business such as the specific customers, the inventory, backend product, and financing available, according to its defined Profit Mandate.

Providers interact with each other through a messaging subsystem that is capable of both point-to-point and broadcast communications. The communications patterns and types of messages vary with the type of Provider and its relation to other Providers in the system.

Providers also interact with external third-party systems (lenders, backend product providers, inventory management system, customer management systems, and so forth) for a variety of business logic purposes. The specifics of these interactions depend on the third-party system, but are often via web services, REST services, or batch file transfer.

The relationships between Providers are based on the relationships between the modeled business units. For example, although a dealership may purchase inventory from any wholesaler, in practice that dealership may normally obtain stock through a small subset of the available wholesalers.

Businesses may model most of their relationships on either a whitelist or blacklist basis. The differences are:

### Blacklist

In a blacklist model, any provider will typically interact with any other suitable provider unless the relationship has specifically been marked otherwise. This, for example, would allow a dealership to obtain vehicles from any wholesaler including newly added wholesalers, unless an authorized person for that dealership has identified specific wholesalers which must be avoided.

The blacklist model is the most flexible in that as new Providers come online, they become immediately available. It also requires the least initial and ongoing configuration and is therefore the default model.

### Whitelist

In a whitelist model, Providers will interact only with those other Providers that are explicitly identified. This, for example, would allow a dealership to say that they're only interested in using specific vehicle inspection companies.

Some types of relationships are always limited to either blacklist or whitelist models. For example, since a dealership always needs to establish a business relationship with a lender before that lender will provide funding, the Retailer-Lender relationship always follows the whitelist model.

In addition to the whitelist/blacklist behavior, inter-Provider relationships are also used to tune various business rules, such as what kind of discounts or incentives are offered, or the timing of various events or offers. For example, a Retailer may give a preference for scheduling vehicle maintenance with their own departments first, followed by preferred partners, before opening a service order request to any service centre.

### Root Provider

While other Providers in the system are intended to support one type of Ideal user or another, the Root Provider is the interface and control system through which Ideal staff interact, as well as acting as a central authority for various operations and data.

The Root Provider's subsystems provide for the major pieces of functionality as described below:

### Synchronization of Key Data

In any distributed system, there must be an agreement as to the definition and semantics of certain key pieces of information. For example, at any given time the auto industry has a general understanding of the various makes, models, and styles that exist.

While some types of data are static and can be modified during normal software updates, some is dynamic and must have a common definition among all providers, regardless of whether that data is originated centrally or by a participating provider. The Root Provider acts as a common synchronization point for this kind of data.

### Provisioning

Provisioning is, in essence, the way in which a dealership, wholesaler, services company, lender, or other business is onboarded into Ideal, as well as the orchestration of related changes or eventual retirement of the business. The Root Provider is responsible for the orchestration of this task.

Provisioning includes but is not limited to the following: collection of appropriate Provider information (the company particulars, their type of operations, level of service, and so forth); and controlling the full lifecycle of the software components and other resources necessary to support that Provider, including its connection to the system as a whole and the monitoring of active Providers.

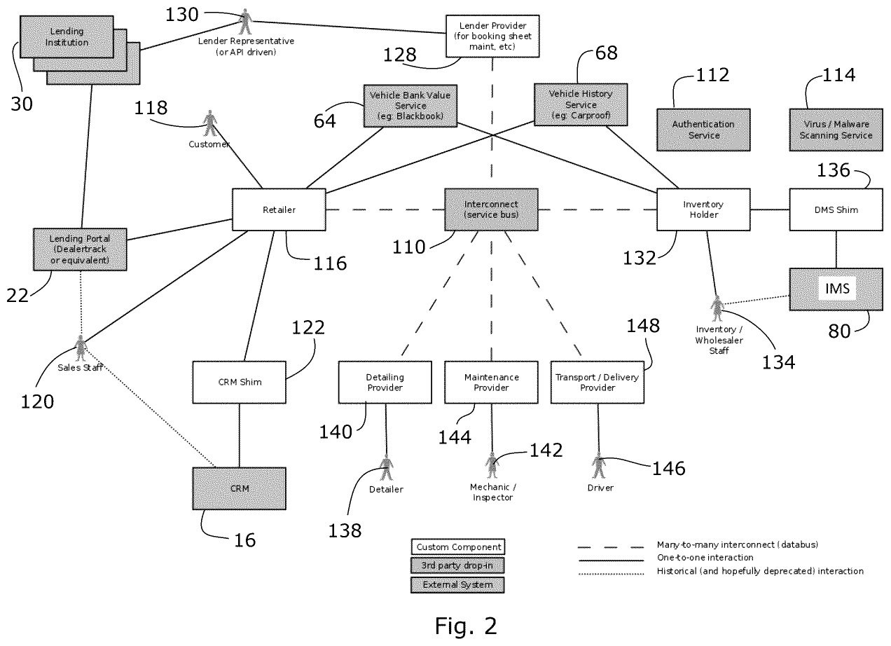

FIG. 2 is a diagram showing an example system including components that are controlled by different entities. As shown in FIG. 2, some system components may be custom components and others may be third party components. In the specific example shown in FIG. 2, an interconnect service bus 110, authentication service 112 and virus/malware scanning service 114 may be 3rd party drop-in components. Other grey boxes 16, 22, 30, 64, 68 and 80 show conventional third-party components that are not considered part of the system but provide information to be used by the system. White boxes show elements that are custom components in this example. The interconnect service bus 110 may be, for example, an internet-based messaging service. A retailer component 116 may interact with a customer 118 and/or sales staff 120 at the retailer and also interact with a Customer Relation Management system (CRM) shim 122 to interact with the retailer's customer relationship management software 16. The retailer component 116 may also interact with lending portal 22 which interacts with one or more banking institutions 30. There may also be a lending provider component 128 (for example for booking sheet maintenance as described below) that the bank 30 may interact with via a representative or API 130. An inventor holder component 132 may interact with inventory holder staff 134 and with the inventory holder's inventory management software 80, via IMS shim 136. A detailer 138 may interact with the interconnect 110 via detailing provider component 140; a mechanic 142 may interact with the interconnect 110 via maintenance provider component 144; and a driver 146 may interact with the interconnect 110 via transport/delivery provider component 148. The retailer 116, Lender Provider 128, detailing provider 140, maintenance provider 14, transport/delivery provider 148 and inventory holder 132 components may each interact via the interconnect 110 in a many-to-many interaction so that different combinations of each can come together to make a transaction work. The inventory holder component 132 and retailer component 116 may each interact on a one-to-one basis with valuation provider 64 and inventory history provider 68. The selection of which interactions are one-to-one, and which are many-to-many may be varied in different embodiments, but in general, one-to-one interaction tends to occur between different items particularly owned by a single entity (e.g., different inventory holder components or retailer components) and unique entities that require special programming are also more likely to be interacted with on a one-to-one basis.

### Collection and Analysis of Aggregate Statistics

While Providers collect and analyse data that is within their scope of visibility, some information is visible only to the system as a whole. The Root Provider provides for the collection and analysis of this system-level data and makes it available to the appropriate provider types in a fashion that does not expose business-sensitive or personally identifiable information in an inappropriate way.

### Billing Metrics

The Root Provider is responsible for tracking and reporting on such metrics as is necessary to support Ideal's business model. For example, where Ideal is compensated on a per-transaction basis, the Root Provider is responsible for the collection and reporting transaction counts for each active Provider.

### Inventory Provider

The Inventory Provider subsystem provides the functionality required to support those organizations which hold inventory. This is typically either a wholesaler or the inventory management department of a retailer (i.e., dealership). Many organizations may have their own third-party inventory management systems (IMS); however, the Inventory Provider subsystem is not intended to supplant these systems; it is intended to augment an IMS when available in order to provide additional functions specific to Ideal. For cases where there is not a separate IMS, the Inventory Provider subsystem provides the minimum essential functions of an IMS.

Example functions of the Inventory Provider are described below.

### Stock Ingest and Update

The Inventory Provider, in order to perform its other tasks, must have access to stock. Under normal circumstances, the Inventory Provider imports inventory data from an IMS, provides updates to that IMS (such as to mark a vehicle as unavailable when it gets purchased through Ideal, or when there is a change in the description of the vehicle), and accepts updates from the IMS (such as when the description or availability of a vehicle changes).

To facilitate situations where there is not an external IMS, or where the integration to the IMS is incomplete or otherwise unavailable, or needs to be augmented, the Inventory Provider has basic input/output capability, including batch import from sources such as CSV files or spread sheets.

Regardless of the data import capability, inventory data is validated upon import and invalid data will result in the specific records either being rejected or held in quarantine until they can be corrected.

In addition to basic vehicle descriptions, the Inventory Holder maintains other records that affect the saleability of the vehicle including damage, repair, inspection, and related records.

### Single Vehicle Sales

The Inventory Provider facilitates wholesale transactions of single vehicles between itself and Retailers or other Inventory Holders. The first stage of such a transaction is responding to vehicle requests from Retailers:
1. Listen for vehicle requests
2. Determine whether or not to respond to the request based on whitelist/blacklist rules.
3. Identify the available vehicles that are consistent with the request.
4. Create a time-limited vehicle offer that is specific to the requesting Retailer.
5. Transmit vehicle offers to the requesting Retailer

The second stage involves the wholesale transaction itself, which can come in a few flavours:
1. Listen for counter offers, which may be accepted, declined, or result in an amended vehicle offer
2. Listen for hold requests, which may be accepted (perhaps subject to a deposit or other conditions) or declined
3. Listen for purchase orders, which may be accepted or declined (such as in the case where the stock is no longer available)
4. Listen for notifications of posting deposits or payments
5. Listen for cancellation of holds or purchase orders

### Wholesale Packages

An Inventory Holder has the option of grouping vehicles together in a Wholesale Package. Often this is used to try to move out unwanted stock by offering package price that is a discount from the sum of the individual vehicle prices, however the package price may also be equal to or greater than that sum.

Wholesale packages are sold on an all-or nothing basis. A vehicle may concurrently be part of more than one wholesale package and may also be concurrently offered for sale as an individual sale.

If the Inventory Holder accepts a purchase order for a vehicle or a wholesale package, then any other package that contains that vehicle (or contains any other vehicles within the package to which the purchase order refers) are immediately invalidated; the remaining constituent vehicles of those invalidated packages may be used in other or new packages, but the invalidated packages are permanently unavailable.

Placing a hard hold on a vehicle will temporarily suspend any packages containing that vehicle. Vehicles on which an active hold has been placed cannot be used in the creation of new packages, nor in the creation of new vehicle offers, other than those which were created as a consequence of a counteroffer for a vehicle offer for which that vehicle was part.

An Inventory Holder will only advertise or provide Wholesale Packages to another Inventory Holder.

An Inventory Holder may create a Vehicle Offer for any vehicle that it holds, as well as a Vehicle Offer for a Retailer based on any available vehicle it sees in Wholesale Packages from other Inventory Holders, provided that the offer is for a single-vehicle sale.

In addition to allowing an inventory manager to create, maintain, and remove wholesale packages, the Inventory Provider supports building wholesale packages automatically, while still permitting a manager to provide final approval on those packages. In cases where packages get invalidated (such as a subset of constituent vehicles being sold outside that package), the Inventory Provider also provides mechanisms to roll the invalidated package's vehicles into a new package, ready for modification, rather than requiring the user to start again from the beginning.

### Advertisements

Inventory Holders proactively let other providers know about available vehicles and wholesale packages. These come in the form of Advertisements.

While Advertisements can be sent to a subset of Retailers and Inventory Holders, their content does not contain any per-provider discounts or incentives. Given an Advertisement from another Inventory Holder, a Retailer or Inventory Holder can obtain a Vehicle Offer, perhaps containing discounts or incentives, by asking the other Inventory Holder for an offer based on the VIN.

### Current Stock Valuation and Recommendations

Through the use of the Vehicle Evaluation Engine (V-EVAL) an Inventory Holder is able to obtain the estimated current and future value of a vehicle, an estimate of the ease of obtaining financing for a specific vehicle with respect to various customer cohorts, and an indication of its suitability to different types of customers. From this, other factors can be identified such identifying the date after which minimum profit targets will not be met, the date after which the vehicle becomes a loss, and consequently the desirability of discounting the vehicle in order to move it before those dates.

### Potential Stock Valuation and Recommendations

The same kind of calculations that are used to evaluate current stock can be used to evaluate stock that a buyer is considering for purchase. In addition to the usual valuations, this provides the buyer with information regarding potential profits, how quickly the vehicle must be moved, and whether it is likely to be appropriate to the types of customers that are expected in the near future.

### Retailer

The Retailer (Provider) is one of the central Providers within Ideal. It is responsible for orchestrating retail transactions and associated workflows. The retail transaction workflow is broken down into two variants, non-prime and prime, the latter including cash transactions. These two variants differ most significantly in how financing must be arranged for the deal.

### Retail Purchase (Non-Prime)

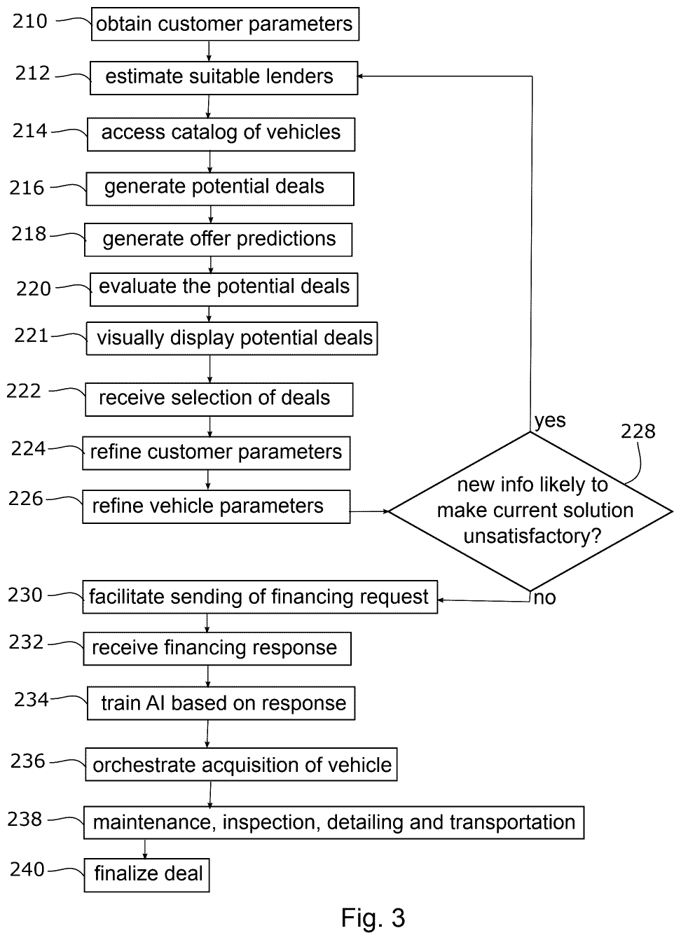

A retail purchase by a customer, who might not qualify for Prime credit, may include the following stages, each of which will be described in greater detail and illustrated in FIG. 3. It should be noted that many of these occur in an iterative fashion; as the quality of information improves for initial stages, the derived data in later stages is updated:
1. In step 210, obtain a set of customer parameters representing characteristics of a customer.
2. In step 212, conduct an initial estimate of suitable lenders, based on the customer parameters, for the purpose of narrowing the scope of the vehicle search.
3. In step 214, query database for suitable vehicles, without identifying the specifics of the customer, deal, or potential lender.
4. In step 216, generate potential deals for the customer using the available vehicles.
5. In step 218, using an analytics engine, which may include a prediction AI component, assess a probability that a lender will provide financing for the potential deals. The analytics engine may include one or more of: algorithmic components, and components based on conventional static and/or heuristic algorithms. These components may use historical data to make one or more analytic decisions or probability assessment. The analytics engine may also use a predication AI component to make a probability assessment.
6. In step 220, evaluate the potential deals in the context of the set of available lenders and provide a visual display of at least some of the potential deals in step 221.
7. In step 222, permit the user to select specific vehicles for further analysis and comparison. This includes providing initial recommendations to the user for suitable back-end products and estimates of all-in costs.
8. In step 224, refine the quality of customer information, including personally identifiable information, allowing the retrieval of credit rating information from a credit rating service and related operations.
9. In step 226, if necessary, refine information about the vehicle in question including obtaining detailed vehicle history and additional valuations.
10. In step 228, iterate over the above process, potentially considering different vehicles and lenders, until a satisfactory vehicle and funding combination is obtained (or it can be determined that there is no combination that is appropriate to this customer).
11. In step 230, permit the user to send financing requests to selected lenders, and facilitate that transaction.
12. In step 232, receive financing response from lender.
13. In step 234, train the analytics engine, which may include a prediction AI, if appropriate, based on the financing response.
14. In step 236, if necessary, orchestrate the acquisition of the selected vehicle from the Inventory Holder.
15. In step 238, if necessary, orchestrate the maintenance, inspection, detailing, and transportation of the vehicle.
16. In step 240, orchestrate the finalization of the deal, including post-delivery tasks.
We discuss some of these stages in more detail, below.

### Step 210—Obtain Customer Information

Non-prime workflow starts with obtaining at least minimal information on the customer, such as the amount that they would like to make in regular payments and their current income. Ideally, the customer also provides a guess as to their credit worthiness (or takes an alternate workflow where their credit worthiness can be determined).

For instance, one alternative workflow can include a determination or inference of a credit worthiness of the customer based on where they live. That is, the address associated with the customer may be mapped to an average credit rating for all those who live in the surrounding neighborhood.

Any level of customer information beyond the minimum, up to and including fully identifying the customer and obtaining their credit history, serves to refine the process and provide better estimates in later stages.

If the customer is planning on providing a vehicle for trade-in, the trade-in information may also be collected.

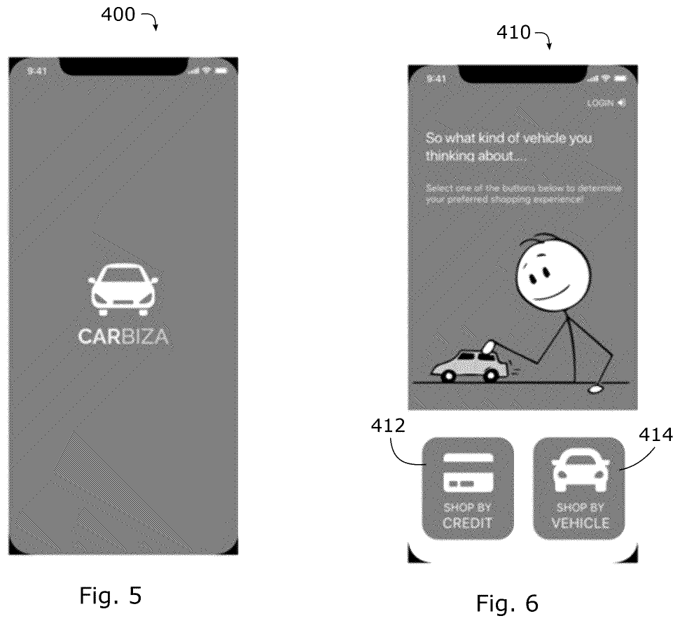

These customer parameters enter the system via an input channel such as a user interface or an internet connection. They may be entered by a customer directly or for example by a retail employee based on communication with the customer. An app by which information may be entered by the customer is described below in relation to FIGS. 5-36, with customer-facing aspects described in relation to FIGS. 5-21.

In situations where neither the payment or income are available, the transaction may be treated as a prime retail purchase and later refined.

### Step 212—Limit Lender Programs

Depending on the customer information provided, some lender programs may be immediately eliminated from consideration. This is typically done based on hard lender rules and known information about the customer. Some examples as to why a program may be eliminated from consideration include:
The customer has credit circumstances or events (late payments, bankruptcies, excessive debt to income ratios) that are contrary to the lender program's requirements.
The customer is new to the country, and the program does not cover recent immigrants.
The customer is outside of the lender's service areas.

Any lender programs so eliminated may be reconsidered in light of updated customer information.

The finance prediction AI, described below, may also be used to eliminate lender programs if a customer is unlikely to be accepted into a program despite being within hard rule bounds.

### Step 214—Search for Available Vehicles

After obtaining basic customer information, a Retailer may send a search to the vehicle database of available vehicles to obtain suitable Vehicle Offers. The user is permitted to specify the obvious set of search criteria including but not limited to body type, year, make, model, style, trim, and feature sets. In addition to user specified criteria, the Retailer may include over override criteria based on customer criteria. For example, if a suitable wholesale price cap can be determined based on the customer's circumstances and the dealership's Profit Mandate, the maximum price limit is set in the search criteria.

When sending a search request to the vehicle database, the Retailer may scope the requests in a few different ways including but not limited to:
1. restricting the search to vehicles from the Retailer's directly assigned Inventory Holder (i.e., searching a dealership's own stock);
2. restricting the search to vehicles from any Inventory Holder that is within the same organization as the Retailer;
3. restricting the search to vehicles from any Inventory Holder that is within a particular geographic area;
4. restricting the search to vehicles from Inventory Holders that have predefined business relationships with the current Retailer; and
5. any matching vehicle irrespective of the Inventory Holders.

The database of vehicles of all vehicles of all Inventory Holders collectively is referred to as a catalog.

### Step 216—Generate Potential Deals

Once vehicle offers are obtained, a deal generator generates deal data elements representing potential deals on vehicles considered, which may be a subset of the total collection of vehicles, for example based on the vehicle selection criteria chosen by the customer. Each deal data element may comprise an association of a vehicle with loan parameters. The deal data element may also comprise additional associations such as with a particular set of backend products, for example insurance products, warranty products and extended service contract products.

The deal generator may generate a single potential deal for each vehicle, or multiple potential deals for each vehicle. The deal generator may be tightly coupled or integrated with the analytics engine, which may include a prediction AI, and the evaluator described below. This tight coupling may be used to improve the quality of deals generated, particularly where only a single deal is generated per vehicle in an iteration of this process.

### Step 218—Predict Loan Offers

Once a selection of potential deals is generated, an initial prediction is made by the analytics engine, which may include a prediction AI, as to what loan offers various lenders may make under their respective programs. For this process, in an embodiment at least the following is determined by the deal generator for each vehicle considered:
the payment call (loan parameters such as amortization, term, rate, finance amount, cost of financing)
a recommended set of backend products

The analytics engine, which may include a prediction AI, may operate on this data to provide an offer prediction indicating a likelihood that the lender would eventually fund this vehicle for this customer.

### Step 220—Evaluate Potential Deals

The likelihood that the lender would eventually fund this vehicle for this customer is one example of an evaluation metric. An evaluator may receive the deal data elements and associate the deal data elements with evaluation scores according to further evaluation metrics. Examples of such further evaluation metrics include:
profit breakdowns (front end, back end, total)
the Profit Mandate Rating (PMR)

Each element of a profit breakdown, the likelihood of funding and the PMR is an evaluation metric. Any combination of evaluation metrics is also an evaluation metric. The value determined for a particular potential deal according to an evaluation metric is an evaluation score.

In an embodiment, the potential deals are ranked on a combination of the funding likelihood and the PMR and displayed to the user in step 221.

In one embodiment, all possible deals considered are displayed to a user ranked according to their evaluation scores obtained according to an evaluation metric. In another embodiment, a subset of potential deals is selected for display based on the evaluation scores, for example all potential deals above a threshold score or with a score corresponding to a threshold rank or better. The subset may be, for example, deals shown in an initial page of results, and further results may be available to a user by scrolling or other input. In another embodiment, the display may show potential deals visually associated with their evaluations according to one or more evaluation metrics.

The evaluator is connected to an output channel for transmitting representations of the potential deals, and any associated information, to the display. Depending on the embodiment, the display itself may be external to the system.

### Step 222—Select Vehicles and Process Worksheets

From the potential deals presented, for example the group of ranked vehicle offers, the user is permitted to select multiple vehicles of interest and the lenders that should be contacted for obtaining actual loan offers. This level of detail is represented by worksheets (one worksheet per customer/vehicle/lender combination.)

During this process, the user can modify aspects of the worksheet such as payment amounts and frequency, and downpayment amount.

During this process the system may provide suggestion or recommendations to the Customer for add-on back-end products. Back-end products may include products and services that do not affect the value of the vehicle itself and include, for example, insurance products, warranty products and extended service products.

The deals presented to the user will typically in all costs including any recommended back-end product add-ons.

Also at this time, in step 224 the level of customer information must be expanded to a level that is suitable for submitting to an actual lender, should it not already have been provided. In cases where a direct connection is used to credit reporting agencies, the customer's credit is also pulled at this stage. In step 226, if necessary, refine information about the vehicle in question including obtaining detailed vehicle history and additional valuations.

During this process, the user may iterate on previous steps, as represented by decision box 228, should the expanded information indicate that the vehicle is no longer an optimal choice.

### Step 230—Request Financing, Solidify Vehicle Selection and Deal Details

Once there is sufficient identifying information on the customer, the vehicle selection has been made and the deal details predicted, the lending institution(s) is contacted with a funding request. This starts the next stage of the iterative process with the objective of obtaining a booked deal. Within Ideal, this process is handled by way of Lender Proxies (not to be confused with the Lender Provider), and which are internal to the Retailer implementation.

This process may involve placing vehicle holds with the sourcing Inventory Holder or committing (as the Retailer) to the wholesale purchase of that vehicle from the Inventory Holder, either singly or as part of a wholesale package.

Those vehicles and funding requests that are not used in the final booking of the deal are released or retired, respectively.

Step 232—Receive Financing Offer from Lender

When a response is received from the lender, which may comprise an approval, including a choice of customer tier, or a declining of the funding request, the response may be forwarded to the customer and may also be used to train the analytics engine, which may include the prediction AI in step 234.

### Step 236-240—Vehicle Acquisition and Post-Booking Actions

Once the Retailer has committed to the wholesale purchase of the vehicle from the Inventory Holder (which does not necessarily correspond to the time that the deal is booked), the Retailer completes this interaction with the Inventory Holder in step 236.

Before the vehicle can be delivered to the customer, there is usually a set of actions that must be performed on the vehicle in step 238, including but not limited to maintenance, repairs, inspection, detailing, as well as the movement of that vehicle, as required, from the sourcing Inventory Holder, through the appropriate service Providers, and eventually to the customer. The Retailer is responsible for initiating these actions, either by placing a direct service order or placing the work out for tender and finalizing that tender. In both cases, the Retailer is responsible for tracking the status of the post-booking work and eventual delivery of the vehicle in step 240.

### Retail Purchase (Prime or Cash Sale)

Workflows were the where the customer qualifies for prime rate financing or pays (or intends to pay) cash are degenerate cases of the non-prime workflow.

In both cases, one major difference is that the initial user interaction is at the point of searching for vehicles, which means that the search must be able to proceed without any information at all regarding the customer. This further implies that any displayed prices are either cash prices (for cash deals) or marked as “as low as”-type prices based on the best possible credit tier (for financed prime deals).

In the cash sale case, any lender specific workflows are obviously bypassed.

At the point in a financed prime rate deal that detailed customer information is being collected, there is no substantive difference in workflow between the prime and non-prime financed cases.

### Lender

The primary workflow of the Lender Provider is to provide the operating parameters that describe the rules under which the lenders will provide funding. One mechanism that a lender may provide information about financing rules is through documents referred to as “booking sheets.”

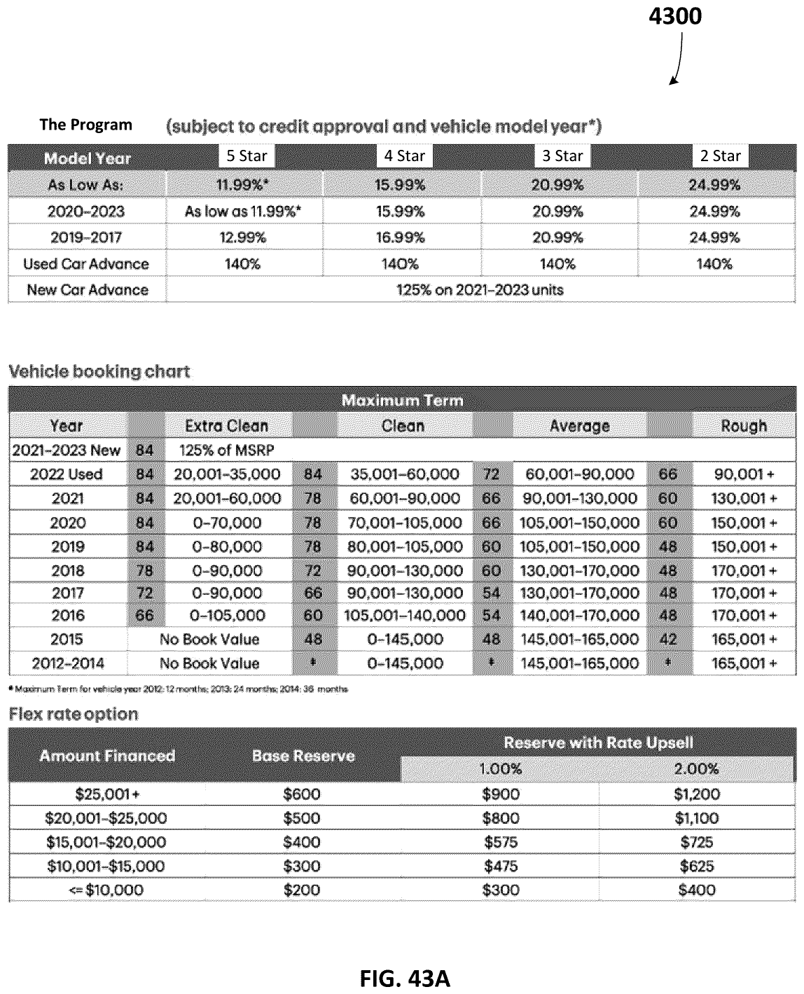

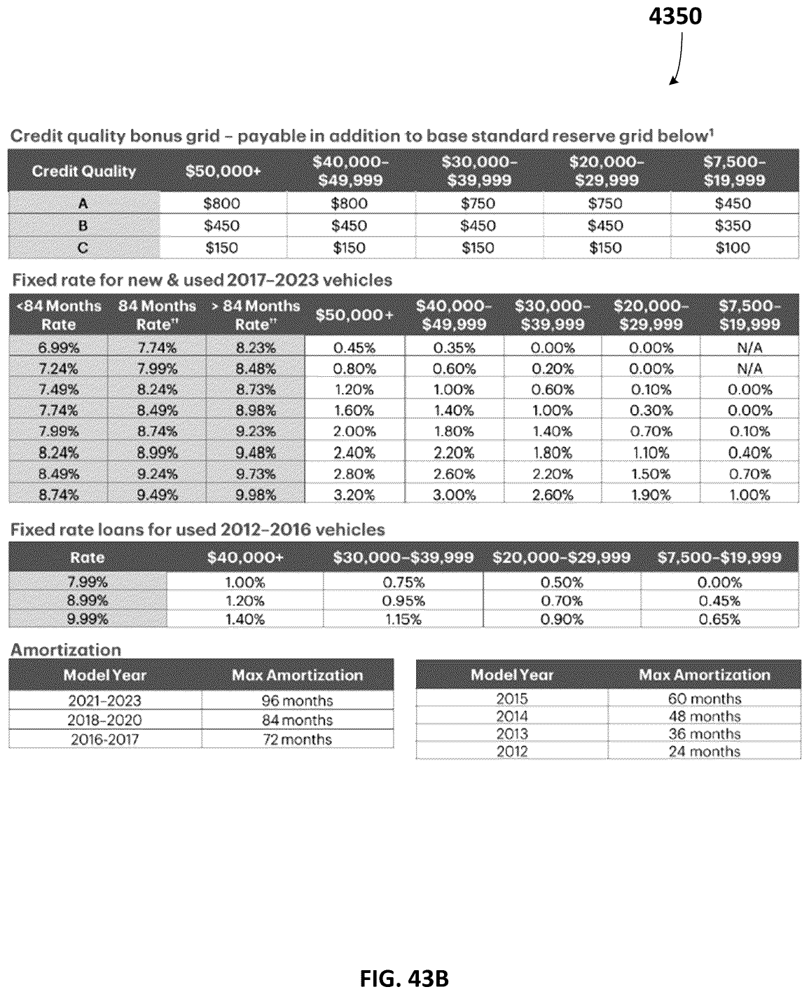

Booking sheets contain information about how the lender may advance credit to a particular consumer. FIG. 43A shows an example Booking Sheet 4300 from a lender for a first group of customers (e.g., non-prime customers). FIG. 43B shows another example Booking Sheet 4350 from the same lender for a second group of customers (e.g., non-prime customers). Booking sheets may include information about interest rates, maximum loan duration, maximum amount that may be borrowed, incentives provided to the Retailer for arranging a particular loan. The booking sheet may also use additional data such as the age and condition of a vehicle being financed, whether the vehicle is new or user or any other factor the Lender uses in determining credit worthiness.

The Lender Provider allows for the entry and upkeep of information contained in the Lender booking sheets (booking sheet maintenance as mentioned in relation to FIG. 2) which are common to all dealerships within a region, as well as general information on their offerings such as the set of available tiers. This can either be via manual entry from a lender representative, or as an automated data import from a cooperating lender information system. The information could also be manually entered by someone else, such as for example an Ideal employee, based on information provided by the lenders.

A secondary workflow is the management of conditions and incentives from a Lender that are applicable to a specific Retailer.

### Services Provider

In both the pre-sales and post-sales cases, vehicles will typically require some sort of services to be performed. This can include maintenance, inspection, repair, detailing, transportation of the vehicle, and similar services.

A Services Provider can offer all or a subset of these kinds of services. Often dealerships will have an in-house service centre that acts as a Services Provider, and sometimes it is outsourced to an external party. Ideal allows a dealership to use in-house, closely related, and external Service Providers, and do so in a fashion where different services could be fulfilled by different providers, through the use of a service order management system.

The primary operations of a Services Provider are:
1. Listen for requests
2. Evaluate and recommend as to whether or not the request should be actioned.
3. In cases where an automated submission is feasible, broker that submission.

If a request is granted and a third-party service scheduling application is in use:
1. Provide enough information the third-party scheduler is able to action the request.
2. Obtain from the third-party scheduler request completion or alteration information.

If a third part service scheduling application is NOT in use:
1. In preparation of submitting a request, allow staff to create, estimate, and schedule supporting tasks.
2. In the processing of an accepted request, allow staff to create, update, or delete supporting tasks.
3. In the processing of an accepted request, allow staff to update the status and other related information.
6. Propagate request completion and related information back to the issuing Provider.
7. Provide for the extraction of summary information suitable for billing.

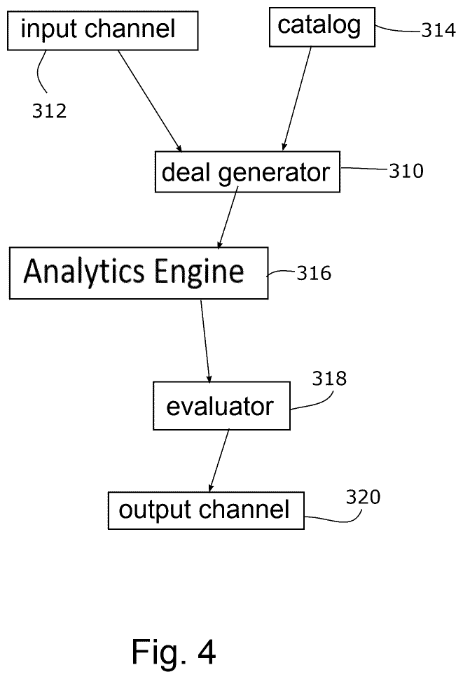

A system as described here is shown schematically in FIG. 4. A deal generator 310 may be connected to an input channel 312 and a catalog 314 containing data on vehicles in a collection of vehicles to generate deal data elements each representing a respective potential deal, each deal data element comprising an association between loan parameters generated by the deal generator and a vehicle of the collection of vehicles.

An analytics engine 316, which may utilize machine learning or artificial intelligence techniques, may be connected to the input channel 312 and to the deal generator 310 to generate offer predictions predicting responses of one or more lenders to financing requests for the potential deals represented by the deal data elements for the customer.

An evaluator 318, which may utilize machine learning or artificial intelligence techniques, may be connected to the analytics engine 316 to generate evaluation scores for the deal data elements representing potential deals on vehicles of the collection of vehicles, based on evaluation scores for the potential deals according to an evaluation metric taking into account the offer predictions and may select a subset of the deal data elements based on the evaluation scores. The evaluator 318 may be connected to an output channel 320 for transmitting representations of the subset of potential deals for visual display or for transmitting a representation of the potential deals visually associated with their evaluations according to the one or more evaluation metrics. When one element is connected to another, this connection may be direct or indirectly via another element.

### Vehicle Evaluation Engine

The Vehicle Evaluation Engine (V-EVAL) is a subsystem by which a Specific Vehicle or a Representative Vehicle may be evaluated with respect to for various attributes. Examples of attributes that may be evaluated include, but are not limited to, the estimated current value for the vehicle, estimated future values for the vehicle at one or more times in the future, or a measure of the how easy or difficult it will be to obtain financing for the sale of the of the vehicle. The results of the V-EVAL are used by Retailers for trade-ins, and by Inventory Holders for both assessing current inventory and evaluating potential purchases.

### Valuations

The primary valuation mechanism is one of considering a group of Valuation Sources and calculating a weighting function across that group of Valuation Sources, where the weighting function can be customized on a per-user basis.

A Valuation Source is responsible for examining all the known information, and the set of unknown information, regarding a vehicle and providing:
1. An estimate of the current value of that vehicle.
2. The value adjustments that are applicable for that vehicle. A value adjustment is a modification to the baseline price of a vehicle.
3. The set of value adjustments that the source is able to apply in general.

It may also optionally provide:
1. The estimated error of the current value;
2. A set future values; and
3. Estimates of the error in future values.

The set of Valuation Sources includes, but is not limited to:
1. Historical records of Representative Vehicle values seen in Ideal wholesale transactions.
2. Historical records of Specific Vehicle values seen in Ideal wholesale transactions (for those vehicles that have previously been sold within Ideal by or to the estimating organization).
3. 3rd party sources of Representative Vehicle retail or wholesale value (e.g., Canadian Blackbook, Kelley Bluebook)
4. 3rd party sources of Specific Vehicle retail or wholesale value (e.g., Carproof)
5. An “expert opinion” source, whereby an experienced user can provide a valuation guess.

In addition to the value adjustments provided by Valuation Sources, the V-EVAL also has a set of standalone Valuation Adjusters. These Valuation Adjusters include but are not limited to:
1. A configuration adjuster, where the value is modified based on the specific vehicle type and configuration and their historical effect within Ideal
2. A regional adjuster, where the value is modified based on the region of sale.
3. A seasonal adjuster, where the value is modified based on annual cycles.
4. A damage adjuster, whereby the cost of identified current repairs may be estimated based on historical records of similar types of damage on equivalent vehicles.

The standalone Valuation Adjusters may be used by the V-EVAL to modify results of Valuation Sources where those sources do not already perform the equivalent operation.

Based on the Valuation Sources and Valuation Adjusters, the V-EVAL merges the valuations according to a user-defined weighting function. The parameters of the weighting function include:
1. The contribution that should be made by the source, relative to other sources, for the current value.
2. The contribution that should be made by the source, relative to other sources, for future values.

The merged valuations may include both current and future value estimates. In providing the merged valuations, the V-EVAL also provides statistical measures, numerically and graphically, of the merged valuations including deviation, related error estimates, and measures of the contributing sources.

In addition to the individual and merged valuations, V-EVAL also maintains correlation statistics in order to identify potential dependencies between the valuation sources which may bias the merged valuations.

While the V-EVAL provides estimates for current and future values, the end user is able to override the accepted value. In doing so, Ideal maintains all values, calculates and shows differences and deviations, and may require the user to provide justification for the override, for audit and analytical purposes.

### Determine Ease of Obtaining Vehicle Financing

While the current and future value of a vehicle is useful for current stock, it provides only part of the picture when it comes to making decisions about vehicle acquisition, including trade-ins, in the non-cash and particularly nonprime market. One other major factor is how easy or difficult it will be for an arbitrary prospective customer to obtain financing to purchase the vehicle, which is not only a factor of the vehicle, but also of the likely future customer and lender.

V-EVAL fulfills this function with assistance from the Lender Decision Engine (LDE), with the latter running in a mode that is not necessarily examining specific deals or customers. In this mode, LDE makes predictions based on categories of potential retail customers. This provides V-EVAL with information about the easy of obtaining financing for the vehicle, one for each applicable retail customer category, based on the most likely lenders for those categories.

### Lender Decision Engine

Conducting any type of interaction with an actual Lender uses resources of that Lender, in many cases requires human interaction, may impact the Lender's willingness to partner with the Retailer, may increase costs to the Retailer, and in all cases requires stringent auditing mechanisms.

The Lender Decision Engine (LDE) is a subsystem that provides the following principal functions:
1. Predict, within the bounds of Ideal, how a lender will react to various transactions, should those transactions actually be initiated.
2. Act as a proxy to the actual Lender transaction system, or a 3rd party system supporting the Lender, in order to insulate the rest of Ideal from Lender-specific rules and interactions and broker the business transactions.

The LDE's role as a proxy to the actual Lender transaction system is only ever used in the context of a Retailer. The LDE's predictive functions can be used in the context of both a Retailer or an Inventory Holder, however the type and quality of information available to the LDE in those two cases will generally differ.

### Predictions

### Preapproval Predictions

A preapproval prediction encompasses the information a lender is expected to provide, should one seek an actual financing preapproval. This does not look at parameters surrounding particular vehicles, but rather focuses on aspects of the customer, for example, some or all of employment status, income, total outstanding debt and credit history, and may include several other factors. The key information that the preapproval prediction provides includes the maximum loan amount, the maximum term and amortization, interest rate, as well as additional Ideal-specific information such as likelihood of the lender making such a preapproval and likelihood estimators for the accuracy of the predictions.

The preapproval prediction, when created for a specific customer, helps bound the set of suitable vehicles for that customer.

When used outside the context of a specific customer, such as when an Inventory Holder is calculating vehicle evaluations, the preapproval predictions assist in assessing the ease of obtaining financing for a vehicle for customers of different tiers. It therefore is part of the workflow whereby classes of vehicles can be targeted by buyers to fulfill expected customer demand, as well as predicting potential profits of specific vehicles should those vehicles be acquired.

### Offer Predictions

An offer prediction encompasses the information a lender is expected to provide, should one seek an actual financing approval for a specific customer for a given vehicle. The LDE may use any use preapproval predictions, vehicle information, lender booking sheets, historical Ideal transactions, and related information to create this prediction. The offer prediction includes much of the same information as a preapproval, updated for a specific vehicle, as well as additional information such as profit breakdowns.

### Transactions

### Financing Request

A financing request encompasses the information that is submitted to a lending institution for a particular vehicle and customer for a particular deal.

### Finance Offer

A finance offer encompasses the information that is obtained from a lending institution for a particular vehicle and customer for a particular deal and includes the concepts of an acceptance of the deal terms, rejection of the deal or a conditional offer which includes additional conditions which must be met to complete the deal.

### Finance Message

A finance message is a message (consisting of body and metadata) that travels bidirectionally between Ideal and the Lender's system to facilitate unstructured but official communication between the Lender's staff and the Retailer's salesperson, within the context of a specific deal.

### Services Scheduling Engine

Once a vehicle has been booked, there are typically additional actions that must be taken before the vehicle can be delivered to the customer. For example:
1. The vehicle may not be located at the Retailer that made the sale and may be located at another dealer or wholesaler which may require the vehicle to be moved.
2. The vehicle may need maintenance or repairs to be performed.
3. The vehicle will typically need to be inspected for the jurisdiction in which it is being sold.
4. The vehicle may need to be detailed (e.g., cleaned).
5. The vehicle may have to be moved from its current location to one or more locations where the above services can be performed.
6. The vehicle may need to be delivered to the customer at a location other than the Retailer's place of business.

It is the Retailer's responsibility, to schedule these additional items. Typically, one or more members of the Retailer's staff will be assigned to complete these tasks. This process is simplified by Ideal detecting required tasks. For example, if a vehicle has a nonzero VDA, repairs may be required; it may be a Retailer's standard to always perform an oil change before a car is delivered; an inspection if the vehicle is likely required if it has not already passed a recent inspection. And based on these items, where the vehicle originates, where any work has to be performed, and where the vehicle must be delivered, the Ideal system can assist in scheduling transportation.

Assisting in these tasks is the Services Scheduling Engine (SSE). The primary responsibilities of the SSE in a retail sale are:
1. Identify mandatory and recommended pre-delivery tasks.
2. Allow the salesperson or other Retailer staff members to add optional pre-delivery tasks.
3. Determine the initial sequence and target dates for the pre-delivery tasks.
4. Allow the salesperson or other Retailer staff members to modify the sequence and target dates of the pre-delivery tasks.
5. Allow the salesperson or other Retailer staff members to alter the recipients of task service orders.
6. Send out service orders to the appropriate service (maintenance, detailing, or transportation) providers.

The SSE will include multiple approaches to determine the appropriate recipients of service orders:
1. Sending tasks to service providers that are part of, or closely related to, the Retailer's organization.
2. Sending tasks to service providers with which the Retailer has established business relationships
3. Sending tasks to other service providers, perhaps within specific geographic regions.
4. Sending ad hoc service orders, which require the manual intervention of Retailer staff members when none of the above approaches fulfill the requirements.

As with the Retailer/Inventory Holder interactions, a given provider can alter the distribution or receipt and acknowledgement of service requests through a whitelist or blacklist mechanism.

### Mobile or Desktop Application (App)

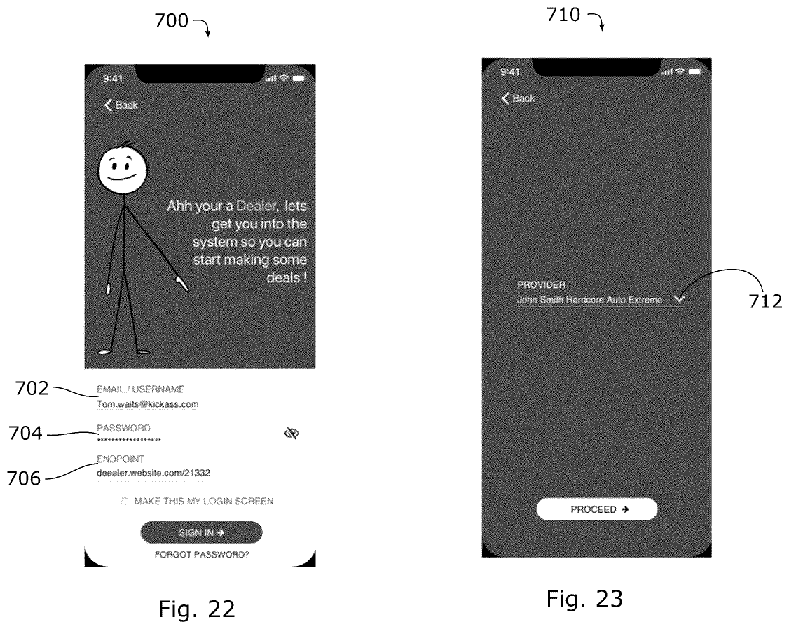

A mobile application program, a desktop application program or an interactive WWW website (collectively referred to as an “app”) may be used to allow dealers and customers to interact with the system and with each other. FIGS. 5-36 show example screens for such an app. Although presented as a cellphone app, the same features could be implemented in, for example, a webpage or desktop application. FIGS. 5-21 show example screens for a customer and FIGS. 22-36 show example screens for a dealer. The dealer and customer screens may be presented in the same app for different users depending on information entered or may be presented in different apps.

FIG. 5 shows an example loading screen 400 for a customer. FIG. 6 shows an example initial choice screen 410 giving options to the customer, for example a shop by credit option 412 and a shop by vehicle option 414. If selected, the shop by credit option 412 will lead to a flow of screens in which the customer is presented with a variety of vehicles appropriate to the customer's budget and credit score. The flow of screens presented here is for the shop by vehicle option 414.

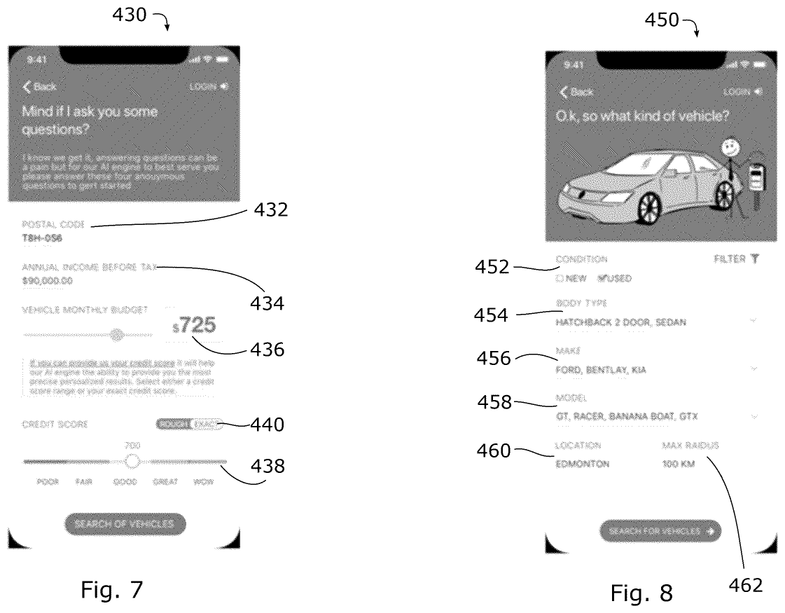

FIG. 7 shows a customer parameter entry screen 430 having, in this example, a postal code data entry field 432, an income data entry field 434, a monthly vehicle budget data entry field 436, and a credit score data entry field 438. The customer parameter entry screen allows the customer to provide these customer parameters to the system, as indicated in step 210 of FIG. 3, to begin the estimation of suitable lenders, as indicated in step 212 of FIG. 3. The credit score data entry field 438 may include an option 440 to indicate whether the credit score is known exactly or is a guess. This screen or another screen may also provide the customer with an option for the customer to authorize the system to retrieve the credit score from a credit reporting agency, e.g., Equifax™

FIG. 8 shows a vehicle filter screen 450 to allow the customer to filter on various vehicle characteristics. For example, the vehicle filter screen can include a condition filter 452, a body type filter 454, a make filter 456, model filter 458, location filter 460 and distance filter 462. Filters may optionally be left blank. Based on the filter selections, the system may access a catalog of vehicles as indicated in step 214 of FIG. 3, generate potential deals using the customer parameters and vehicle characteristics as indicated in step 216 of FIG. 3, generate offer predictions as indicated in step 218, and evaluate the potential deals as indicated in step 220 of FIG. 3. The catalog of vehicles can include inventory of dealers who have made their inventory information accessible to the system but can also include other sources such as an online automobile sales systems or some third-party source of automobile inventory.

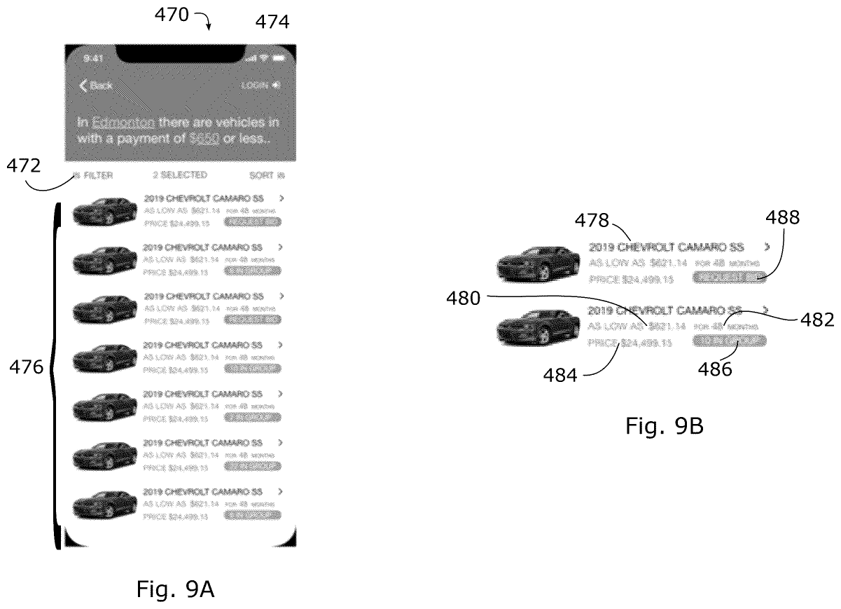

FIG. 9A shows a vehicle list 470. The list may include filter options 472 and sort options 474. Sorting may be by evaluation of potential deals or by other characteristics. The list may be formed of entries 476. To reduce clutter, similar vehicles may be grouped together under a single list entry. FIG. 9B shows two entries 476 from the vehicle list 470 of FIG. 9A Information shown for each list entry can include a vehicle type 478, monthly payment 480, loan duration 482, price 484, and number 486 of individual vehicles to which the list entry corresponds. For entries corresponding to single vehicles, a bid request option 488 may be provided. For entries corresponding to multiple vehicles, a customer may click on the entry to see a sub-list (not shown) where the customer may request bids on vehicles in the sub-list and return to the list shown in FIG. 9A.

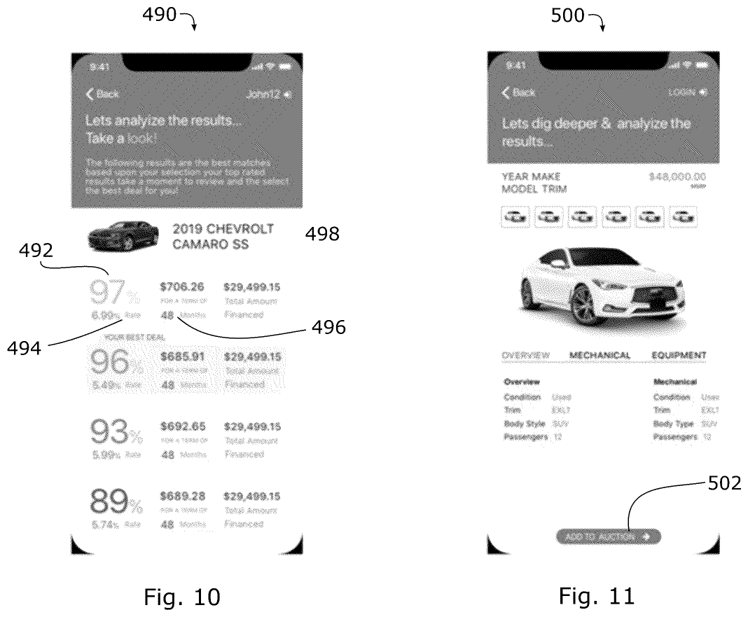

FIG. 10 shows a deal prediction screen 490 showing e.g., information about deal probability 492, interest rate 494, term 496, for a particular vehicle type 498. This prediction screen 490 may be accessed for example by swiping from the vehicle list 470.

FIG. 11 shows an information screen 500 showing information about a vehicle from the list shown in FIG. 9A. This information screen may be reached for example by clicking on a vehicle in the list of FIG. 9A or sub-list described above. In this embodiment a selection option 502 is provided to enable a customer to select the vehicle for an auction.

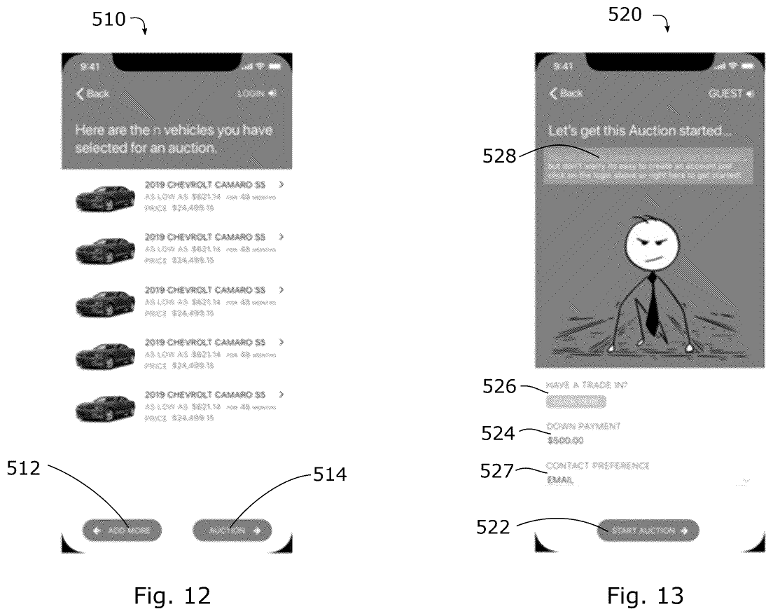

FIG. 12 shows a further list screen 510 comprising vehicles selected by the customer for example via information screen 500 or directly from vehicle list 470. A return option 512 may be provided to allow the customer to add more vehicles and a continue option 514 may be provided to allow the customer to continue to auction start screen 520 in FIG. 12. Depending on the embodiment, a single auction may be restricted to vehicles of one type to aid in comparability. The number of bids for each dealer may also be restricted.

FIG. 13 shows an auction start screen 520. Auction start screen 520 may include an auction start button 522 to start an auction requesting bids respecting the selected vehicles and may also include data entry fields for additional information that may be used for the auction, for example a down payment field 524, and a trade in button 526 that may lead the customer to a screen (not shown) to enter trade in information. The auction start screen can also include contact information such as a contact preference 527. In this embodiment, the customer is prompted to log in or create an account with login/signup link 528 before starting the auction.

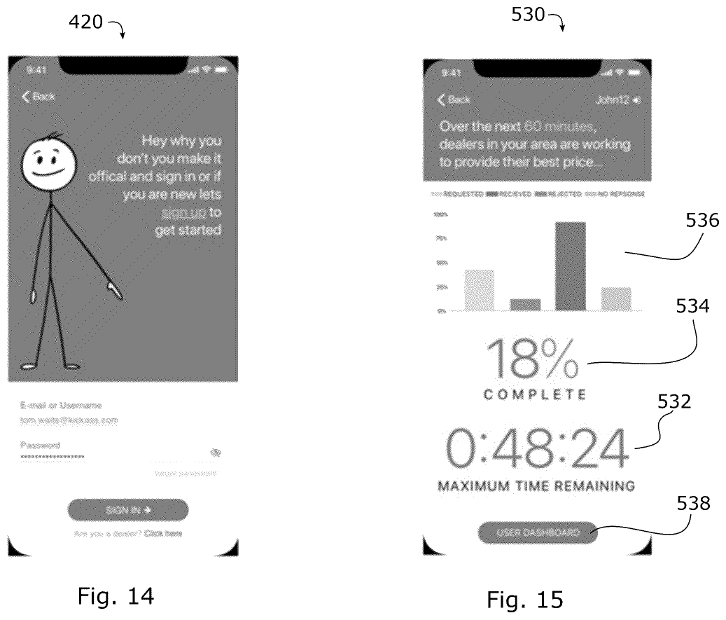

FIG. 14 shows a login/signup screen 420. The login/signup screen 420 may be presented at different stages of the process. For example, to avoid discouraging uninvested customers, the login/signup screen 420 may be presented late in the process, with earlier data entry screens having an option to skip by logging in. Information entered in these earlier screens may be saved and retained in the customer's account.

Once an auction is started, the customer may be directed to an auction progress screen 530 as shown in FIG. 15. In this example, auction progress screen 530 shows a remaining time 532 out of a total time for the auction including a percentage 534 of completion of the total time, and a chart 536 showing summarized information about bid statuses. A link 538 is provided to a customer dashboard screen that will show more information.

Dealers may input bids via a manual process, such as via the app as described below, or automatically using an API. Dealer bids can include price, but also add-ons. In an embodiment, dealers verify the VIN when submitting bids.

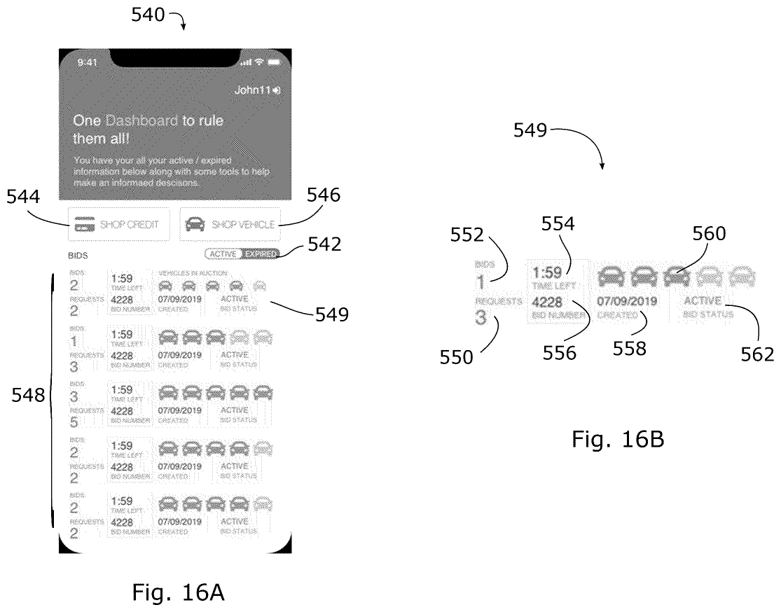

FIG. 16A shows a customer dashboard screen 540. The customer dashboard screen shows information about auctions and bids. An expired auction view button 542 may be included to allow the customer to see expired auctions; expired auctions may be defaulted when no bids are active. The dashboard screen may include additional shopping buttons 544 and 546 to allow the customer to shop and request further bids. The customer dashboard screen 540 may be the default screen shown to logged-in customers. The customer dashboard screen may include a list 548 of auctions, with information about each auction 549. FIG. 16B shows information about an auction 549 from the list 548 such as, for example, number of bid requests 550, number of bids 552, time left in auction 554, bid number 556, date auction was created 558, graphic indication of vehicles in auction 560, and bid status 562.

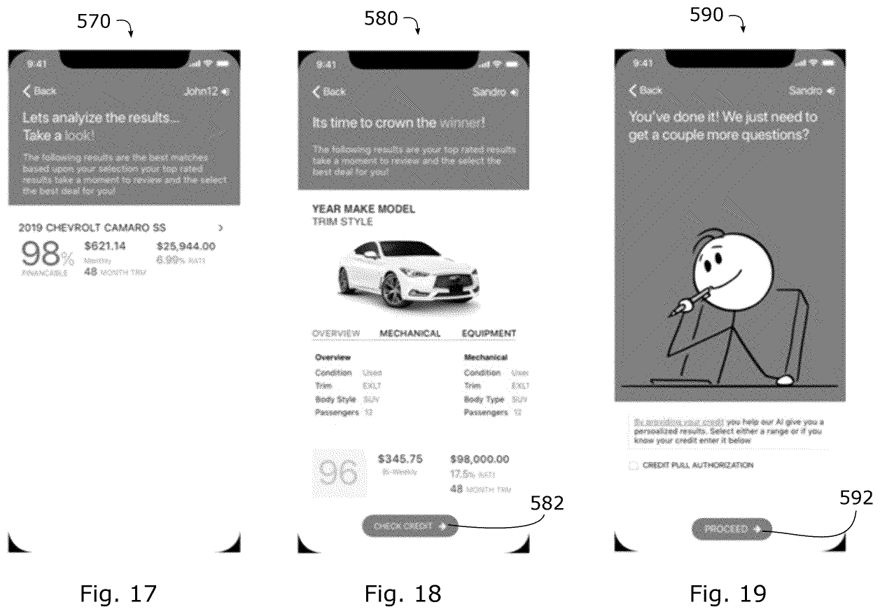

Once an auction is completed, the results may be shown in a results list 570 as shown in FIG. 17. In the example shown in FIG. 17 there is only one result. As in the deal prediction screen 490 of FIG. 10, the results list 570 may show deal prediction information, albeit with enhanced accuracy due to completed bids from the dealers setting e.g., a price. The results list 570 is a visual display of potential deals.

A further results screen 580 may show additional information about the results in the results list, as shown in FIG. 18. The customer may select a deal via this screen, e.g., by pressing check credit button 582 to continue, to send a selection of the deal to the system. Information shown may include, for example, information about the vehicle as shown on information screen 500 of FIG. 11 and deal prediction information.

To finalize a deal, a customer may be asked for additional information such as for example a confirmation of the customer's credit rating. Credit score retrieval authorization screen 590 is shown in FIG. 19 and may be accessed for example via check credit button 582 in FIG. 18. Verification of other information such as an identity check (not shown) may also be performed. The customer may press a proceed button 592 to continue.

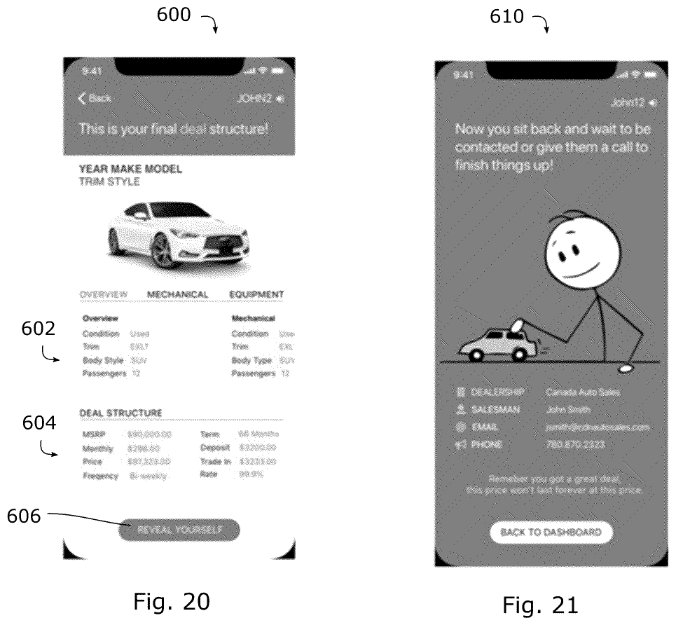

The additional information may indicate that the proposed deal is not viable. If so, the customer may be presented with a failure reporting screen (not shown) indicating this and returning the customer to an earlier step. If the information confirms that the deal is likely viable, the customer may be presented with a success reporting screen 600 as shown in FIG. 20. The success reporting screen may include vehicle information 602 and deal structure information 604.

In an embodiment, up to the success reporting screen 600 the customer may be anonymous to the dealers; the dealers may also be anonymous to the customers. In FIG. 20 a reveal yourself button 606 is provided triggering an exchange of contact information between the customer and the dealer providing the selected bid as shown in contact information screen 610 shown in FIG. 21. The customer and dealer may then finalize the deal through direct contact. In an embodiment the dealer may continue to use the system to facilitate the sending of a finance request, and to use the Services Scheduling Engine as described above. When a machine learning model or other types of artificial intelligence (AI) techniques are used for the prediction of deal parameters, the data obtained from the machine learning model or other AI techniques for successful or failed financing requests may be used to update and train the machine learning or artificial intelligence models as shown in 234 of FIG. 3.

FIGS. 22-36 show dealer-facing app screens which may be used to manually enter bids for auctions initiated by customers via the customer-facing app screens shown in FIGS. 5-21.

FIG. 22 shows an initial screen 700 for a dealer. The dealer may be provided with conventional login screen elements such as email/username text field 702 and password text field 704. The dealer is also presented in this embodiment with an endpoint text field 706. This endpoint text field allows the dealer to enter a web link that the system can connect to obtain access to the dealer's inventory information from software at the dealership. All information on this screen may optionally be saved to allow skipping of the screen on subsequent logins.

FIG. 23 shows a dealership selection screen 710 having in this embodiment a drop-down menu 712 to allow the dealer to select a dealership which they will representing in this session. The menu may be prepopulated, and may have an initial default selection, based on stored information for the user or based on the endpoint entered in text field 706.

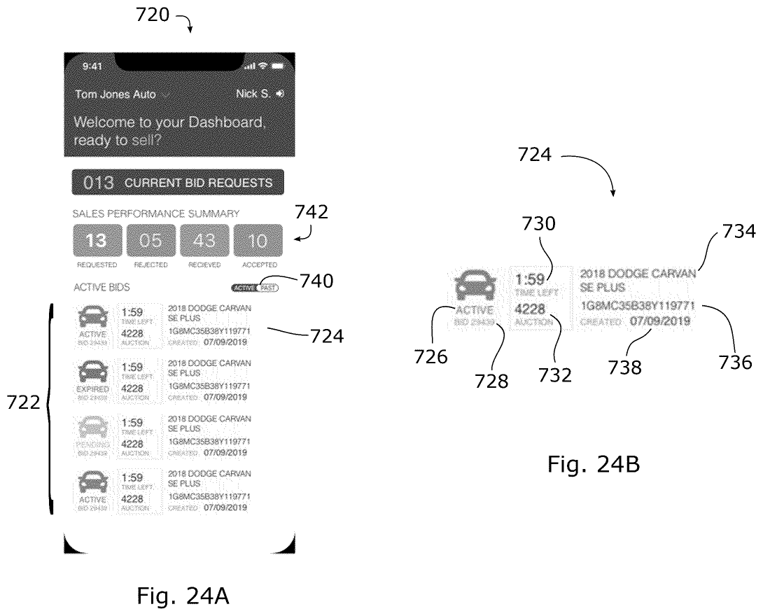

FIG. 24A shows a dealer dashboard screen 720. In this embodiment the dealer dashboard screen shows bids provided by the dealer to customers in response to bid requests. The bid requests are described in more detail above in relation to the customer-facing app screens of FIGS. 5-21. The dashboard screen here includes a list 722 of bid cards 724 representing quotes which are active or which have changed status since the dealer last used the app. The dashboard screen may also include an option 740 to see past quotes. Summary statistics 742 of current and past quotes may also be shown. FIG. 24B shows a bid card 724. The bid cards may include information about the bids, such as for example the status 726 of the bid (e.g., active, pending, expired), a bid identification number 728, remaining time 730, auction 732, make and model 734 of the vehicle, vehicle identification number 736, and date 738 at which the bid was created.

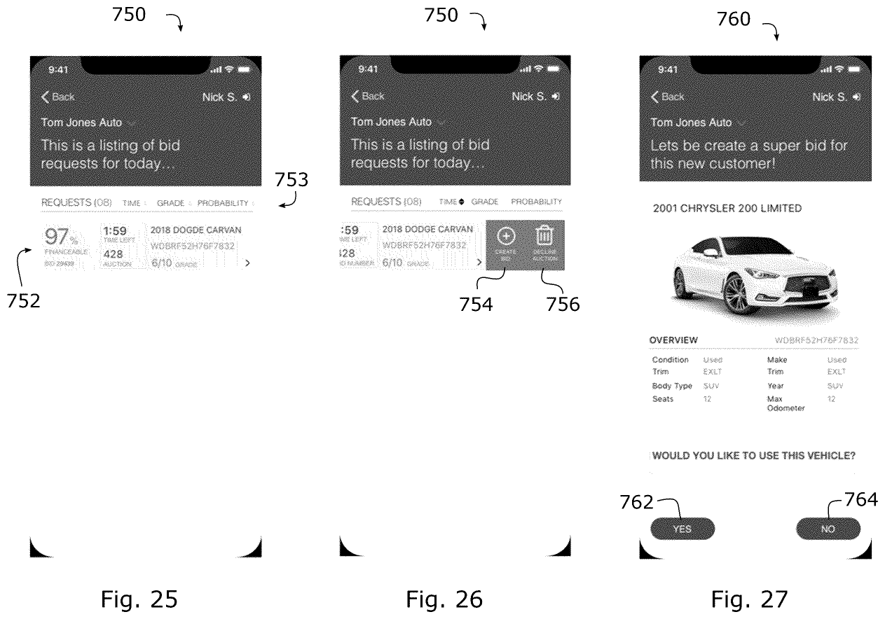

FIG. 25 shows a bid request listing screen 750. The bid request listing screen includes a list of bid requests 752. For simplicity, only one bid request 752 is shown, but more could be included. The dealer may be provided with sorting options 753 for the list, here including time left, grade, and probability that the customer's bid will be financed by a bank. Each bid request 752 may have information about the bid request shown, such as probability that the bid will be financed, time left, bid number, auction number, grade, and vehicle type.

The dealer may choose to create a bid via bid creation button 754 shown in FIG. 26. In the embodiment shown, bid creation button 754 is accessed from bid request listing screen 750 by swiping left. The dealer may also be shown a decline auction button 756 to decline the bid request.

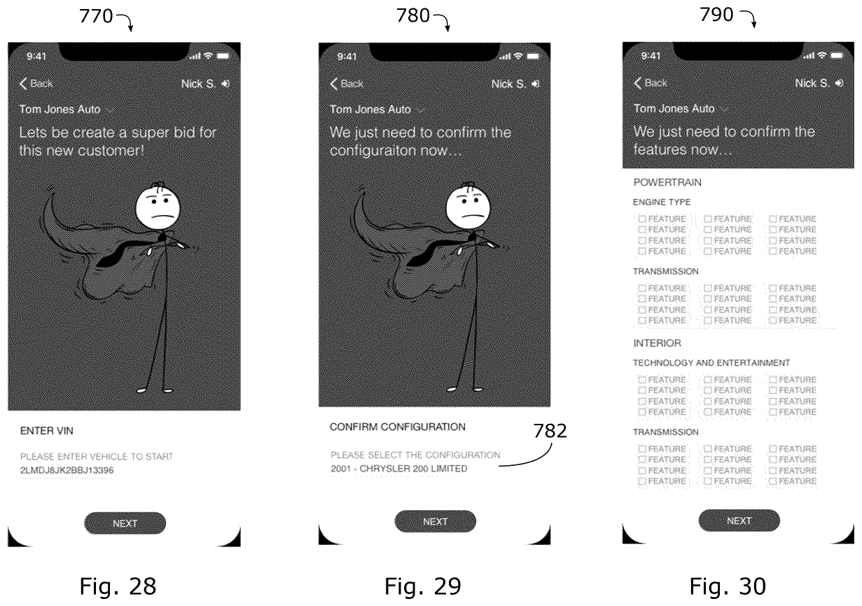

If the dealer chooses to create a bid, the dealer may be shown a bid creation screen 760 as shown in FIG. 27. The system may automatically select a vehicle from the dealer's inventory, by e.g., accessing a catalog of vehicles, generating potential deals, evaluating the potential deals and selecting a vehicle with a best evaluated deal. In this embodiment, bid creation screen 760 shows a selected vehicle with information on the vehicle and provides the dealer with a confirmation option 762 and decline option 764. The dealer may be provided with an option (not shown) to substitute the vehicle with another vehicle the same or better than the vehicle for which the bid was requested. If the dealer selects the decline option 764 the dealer may be presented with a vehicle list (not shown) of possible vehicles on which to submit a bid. If the dealer selects the confirmation option 762 the app may proceed to additional bid creation screens such as for example to VIN entry screen 770 shown in FIG. 28.

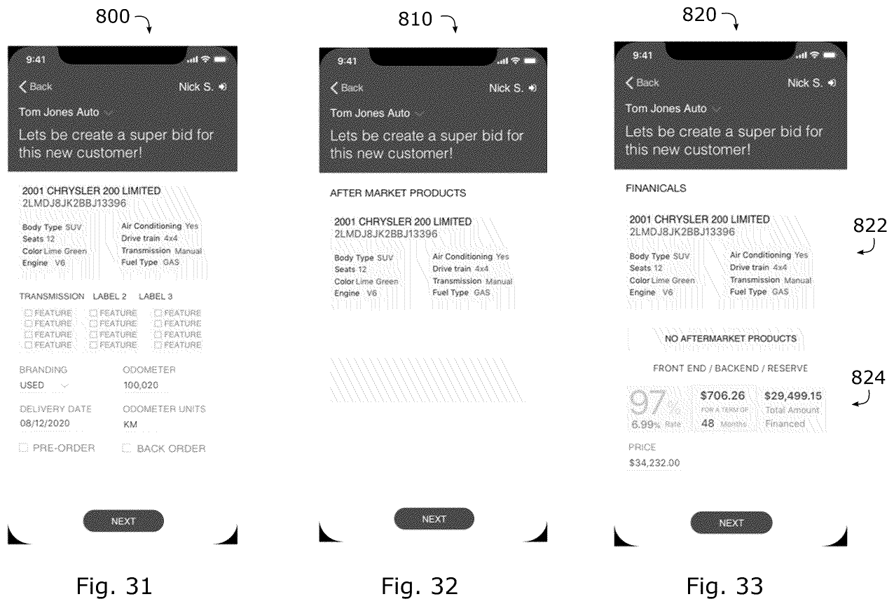

FIG. 28 shows VIN entry screen 770 providing the dealer with a text field to enter the VIN. The dealer may proceed from VIN entry screen 770 to, for example, configuration screen 780 shown in FIG. 29, where the dealer may be presented with, for example, a drop-down menu 782 to select the vehicle configuration. The dealer may proceed to, for example, feature selection screen 790 shown in FIG. 30 where the dealer may select features present in the vehicle. The dealer may proceed to, for example, confirmation screen 800 shown in FIG. 31 which may show information entered at previous screens and/or additional information for confirmation by the dealer. The dealer may proceed to for example, aftermarket products screen 810 shown in FIG. 32 where the dealer may select aftermarket products such as, for example, warranties.

The system may generate potential deals based on, e.g., aftermarket product selections. In FIG. 33, a deal proposal screen 820 is shown including vehicle details 822 and deal details 824. Information can include vehicle configuration and features, warranty, financials, payment front end, back end and reserve. Details may be verified by the dealer; optionally the dealer may be provided data entry fields (not shown) to adjust the details.

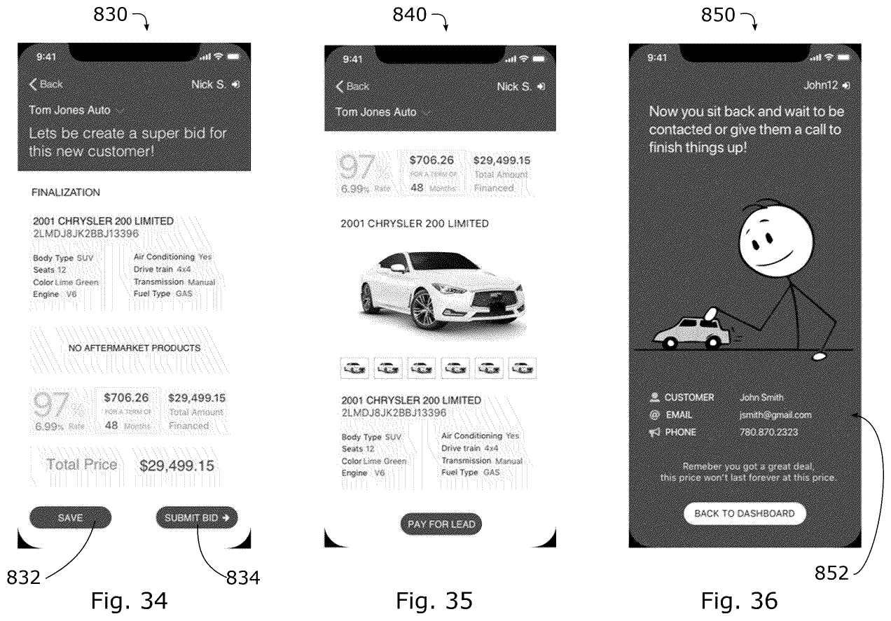

In FIG. 34, a bid submission screen 830 is shown. Details shown may be for example the same as shown in the deal proposal screen of FIG. 33. The dealer may in this embodiment save the bid using bid save button 832 or submit the bid using bid submission button 834. The customer may receive and accept the bid as described above. Once the customer has accepted the bid, the dealer may be shown a bid acceptance screen 840 as shown in FIG. 35. Bid acceptance screen 840 may be accessed for example via a notification or via the dealer's dashboard screen 720 shown in FIG. 24A. In an embodiment, the dealer may pay for this lead from the bid acceptance screen 840 and is shown customer information only after paying for the lead.

Once the dealer has proceeded from the bid acceptance screen 840, for example by paying for the lead, the dealer may be shown a customer contact screen 850, as seen in FIG. 36, showing customer information 852.

The description of FIGS. 22-36 assumes a manual process facilitated by the app. The dealer bidding process could also be automated via an API. A dealer using the API may also use the app to show relevant information about the bidding process, or to manually submit additional bids.

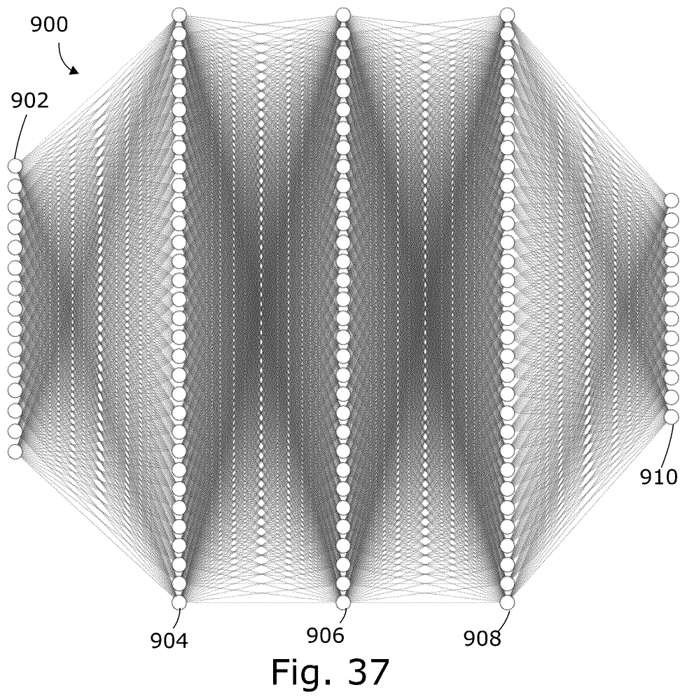

The analytics engine 316 may use machine learning or artificial intelligence techniques such as the use of neural networks. FIGS. 37-39 show example neural networks for a prediction AI. FIG. 37 shows a tier prediction deep neural network 900. The tier prediction deep neural network 900 may be used to generate a prediction of which lending program tier under which a lender is likely to consider a given loan request, taking into account, in this embodiment, the specifics of the customer and their order request, given a specific program from a specific lender. A first layer 902 of nodes may correspond to input data, here characteristics of the customer/request. In an example, there are 14 nodes in first layer 902 corresponding respectively to the following characteristics:
Lender
Lending program
Industry standard credit score (e.g., FICO score)
Credit bureau credit beacon score
Credit bureau risk score
Undischarged bankruptcies
Repossessions
Judgements
Industry standard credit score (co-applicant)
Credit bureau credit beacon score (co-applicant)
Credit bureau risk score (co-applicant)
Undischarged bankruptcies (co-applicant)
Repossessions (co-applicant)
Judgements (co-applicant)

The tier prediction deep neural network also includes a layer of output nodes 910. Output values at the output nodes may correspond to, for example, probabilities over each of the possible lender program tiers, each tier may for example correspond to a respective node of the layer of output nodes 910.

There may also be plural layers of intermediate nodes between the input nodes and the output nodes. For example, there may be three layers 904, 906 and 908. There could also be more or fewer layers. In an example, the intermediate layers may have 512 nodes each. FIG. 37 shows a smaller number of intermediate nodes for readability.

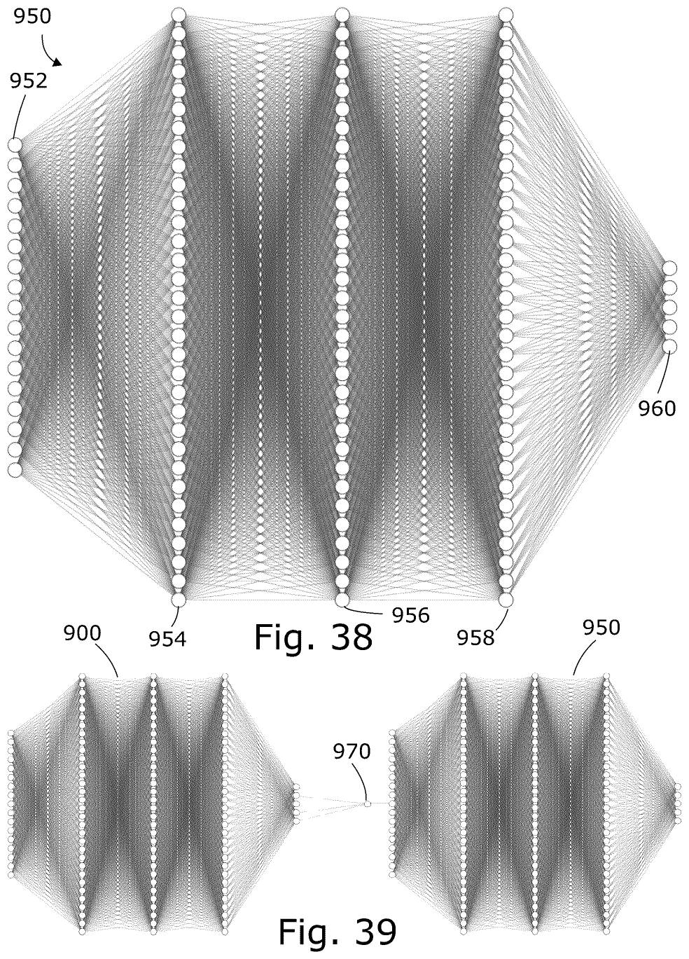

FIG. 38 shows a lender response deep neural network 950. The lender response deep neural network 950 may be used to predict the probability of the possible lender responses given customer/request characteristics and a specified lender, program, and tier (noting that the selected tier may have been output by tier prediction deep neural network 900). A first layer 952 of nodes of the lender response deep neural network 950 may correspond to inputs to the network. In an example, this first layer 952 has 17 nodes corresponding respectively to the following characteristics:
Lender
Lending program
Lending program tier
Employment income
Other income
Employment income (co-applicant)
Other income (co-applicant)
High credit utilization flag
Delinquent trades flag
Public records flag
Thin file flag
Total current instalment debt
Total current instalment debt (co-applicant)
Total current monthly instalment payments
Total current monthly instalment payments (co-applicant)
Finance amount

Lender response deep neural network 950 may also comprise a layer of output nodes 960. The output nodes may respectively correspond to, for example five possible lender responses.

There may also be plural layers of intermediate nodes between the input nodes and the output nodes. For example, there may be three layers 954, 956 and 958. There could also be more or fewer layers. In an example, the intermediate layers may have 512 nodes each. FIG. 38 shows a smaller number of intermediate nodes for readability.

The deep neural networks 900 and 950 can operate independently or together, depending on the needs of the particular customer request. FIG. 39 shows the two networks connected to feed the output of the tier prediction deep neural network 900 into the lender tier input of lender response deep neural network 950. An intermediate node 970 may store the highest likelihood prediction from the tier prediction deep neural network 900 for input as the lender tier for the of lender response deep neural network 950. Alternately, multiple possible lender tiers could be considered, and a final result obtained by weighting of the outputs of the lender response deep neural network 950 for each tier by the probability of the respective tier as calculated by tier prediction deep neural network 900.

### Search Space Optimization

When a customer conducts a search for a potential vehicle for purchase on a webpage or a mobile application, he or she may not have the exact make or model of the vehicle in mind. Often, the customer may simply want to browse what is available, and the associated price and financing information for the available vehicles. At this stage, the customer might only know that he or she wants a car within a certain price range with X amount of dollars as down payment.

A sales manager, whether by hand or with the aid of a computer, would not be able to conduct a search for potential vehicles across a number of Inventory Providers and Retailers, as this would require the sales manager to go through each available vehicle and conduct an individual analysis on whether the vehicle would be a suitable purchase option for the potential customer, taking into account of the customer's needs, financial information, lender payment terms, and so on.

During regional and national operations, the most computationally complex and time-consuming operation in a brute force approach is a bulk search process. Without a layered approach this would involve, for every customer who tries to search for a suitable vehicle for purchase or financing, calculating all potential combinations of funding operations for every vehicle in the search area, while the customer is waiting. This process may involve calculating profit margin for placing each vehicle on hold with the sourcing Inventory Holder or committing (as the Retailer) to the wholesale purchase of that vehicle from the Inventory Holder, either singly or as part of a wholesale package, if the specific vehicle is not already on the lot.

An example embodiment of system described herein implements a search optimization process that can be adapted to conduct searches based on not only inventory at a single dealership, but also between dealerships within a dealer group, between companies that have inventory sourcing agreements with each other, as well as at the regional and national levels.

In some embodiments, the example system is configured to reduce the vehicle search space and apply successive refinements in the searching and selection process.

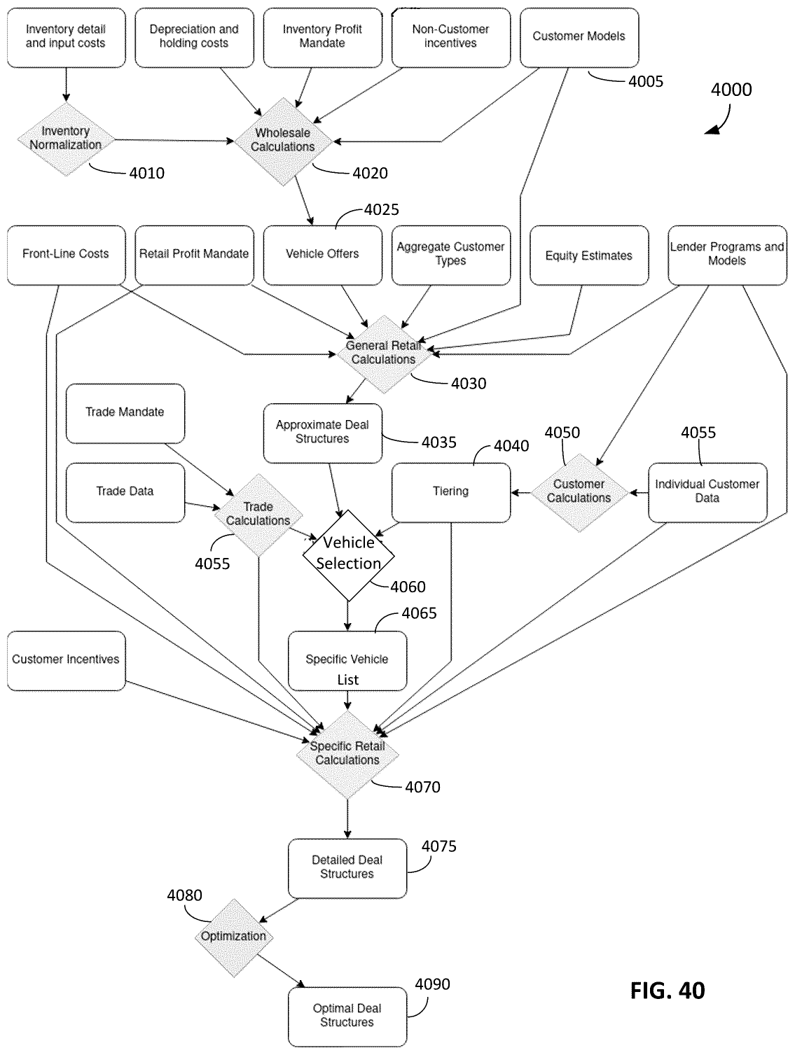

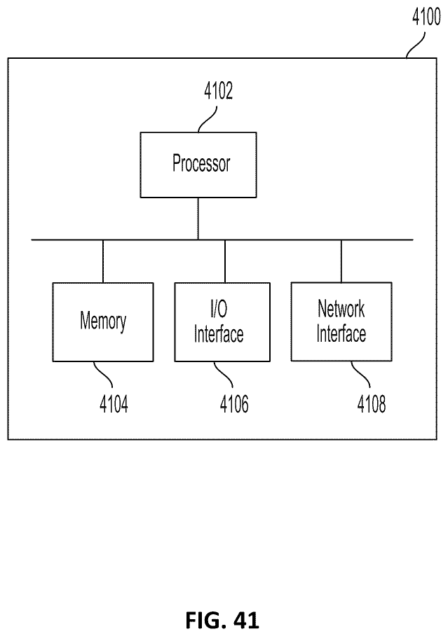

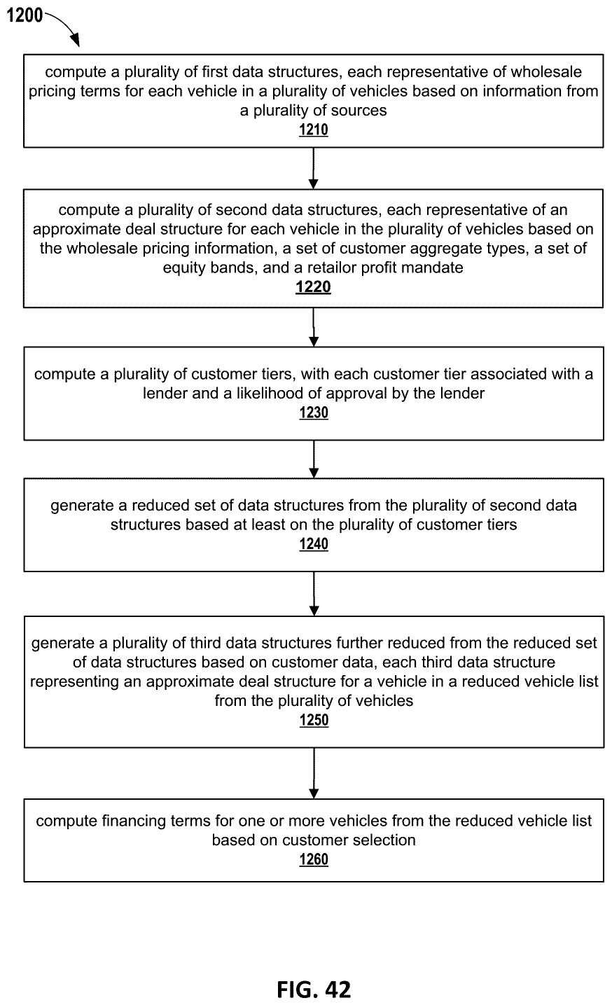

FIG. 41 is a schematic diagram of an example computing device 4100 that performs an example process for search space optimization, such as the process 4000, 4200 described in connection with FIGS. 40 and 42. in accordance with an embodiment. As depicted, computing device 4100 includes one or more processors 4102, memory 4104, one or more I/O interfaces 4106, and, optionally, one or more network interfaces 4108.

Each processor 4102 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 4104 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 4104 may store code executable at processor 4102, which causes training system to function in manners disclosed herein. Memory 4104 includes a data storage. In some embodiments, the data storage includes a secure datastore. In some embodiments, the data storage stores multiple types of data sets, such as textual data, image data, or other types of data.

Each I/O interface 4106 enables computing device 4100 to interconnect with one or more input devices, such as a keyboard, mouse, camera, touch screen and a microphone, or with one or more output devices such as a display screen and a speaker.

Each network interface 4108 enables computing device 4100 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The methods disclosed herein may be implemented using a system that includes multiple computing devices 4100. The computing devices 4100 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 4100 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Referring now to FIG. 40, which shows an example schematic diagram illustrating a process 4000 for generating an optimized vehicle offer, in accordance with one embodiment. The process 4000 includes pre-calculation sub-processes and refinement sub-processes, which are described in detail herein.

In an example embodiment, an example system, such as one implemented using computing device 4100 of FIG. 41, is configured to optimize the searching process by using a layered or tiered approach. The system may be configured to pre-calculate as much information as possible at each stage so that expensive operations can be completed before a customer sends a search query. The system may compute and analyze a wide range of possibilities in order to capture multiple local optimum solutions, and thereby reduce the range of possibilities through a combination of estimations, heuristic and probabilistic means. Once the search space has been reduced, the system may refine the results through recalculation and elimination of inappropriate or unsuitable estimates, and finally, the system may optimize and rank the reduced results, and present the most optimal results on a user display device for a customer to view.

Implementing the search space optimization process enables a system to provide a preliminary set of search results to a customer with little to no customer data, and further refine the search results based on some level of detailed customer data. The optimization process utilizes less computational resource, and takes less time, as compared to a traditional bulk search and selection process, which means the system can handle a large amount of customer queries simultaneously without having to make each customer wait too long for his or her respective set of search results.

The system may be configured to first perform wholesale related pre-calculation sub-processes, e.g., wholesale calculation sub-process 4020, where there is no customer or financing present. Wholesale related pre-calculation sub-processes in some embodiments may be performed by an Inventory Holder, which can be the inventory side of a dealer, but can also be other entities such as rental companies in the processing of disposing of stock. The rationale for calculations provided in this stage is:
to facilitate wholesale deals (e.g., where the purchaser is another Inventory Holder)
to account for the time-dependent value of inventory, including but not limited to depreciation
to construct a baseline for the profit curve, including the determination of optimal base pricing and recommended stop loss conditions

### Inventory Normalization

Prior to wholesale calculation sub-process 4020, inventory normalization sub-process 4010 is carried out to cleanse and streamline inventory data, including inventory detail and input costs from several different systems and vendors.

For example, the inventory normalization sub-process 4010 may receive inventory, and information related to inventory, from multiple sources. The sources may include dealers, manufacturers and other third-party services in the auto industry.

When it comes to identify the exact description or configuration of a vehicle, there may be different descriptions for the same properties of a vehicle. Some of the causes may include:
manufacturers not releasing full information on a vehicle to third parties
manufacturers releasing partial vehicle information, but in a form that is not easily machine-readable
availability of information in natural languages other than English, and inconsistency of mappings between those natural languages
third party information providers using different identification models for vehicles, sometimes in mutually inconsistent ways
errors or omissions in third party information sources
errors, omissions, or sometimes fraud on the part of dealers

In short, when correlating inventory information between sources, often only the most basic of information (e.g., make, model, year) can be directly correlated or deduced with a high degree of certainty. Accurate identification of a vehicle's configuration is important to purchasing and financing decisions, and in some cases the degree of ambiguity between possible configurations can exceed many thousands of dollars and result in a serious impact on the ability to obtain financing for a vehicle for some customers.

In some embodiments, the inventory normalization sub-process 4010 may be configured to: 1) minimize, as much as possible, the degree of ambiguity in data; and 2) when ambiguity exists and cannot be removed, determine the impact of the ambiguity on the deal estimation calculations and propagate that effect as a level of uncertainty in the estimations.

The data from multiple sources may have different data formats, taken from different systems. XML and JSON are two example data formats. The translation of data from different sources are used to determine a number of data items regarding a vehicle, such as for example: current inventory available from dealers, detailed configuration information and aftermarket pricing from BlackBook™, and applicable incentives.

Ambiguity minimization can be based on a combination of approaches applied at multiple levels in the inventory normalization sub-process 4010. The approaches may include, for example: aliasing of often-used terms, heuristic best-match, and probabilistic best-match.

For example, one or more dictionaries may be used to streamline often-used terms.

### Wholesale Calculation

Wholesale calculation sub-process 4020 may receive the input from an Inventory Normalization sub-process 4010, which involves the ingestion and interpretation of inventory, including correlating dirty dealer-provided data with other industry data sources.

Customer models (not individual customers) 4005 may influence wholesale calculations in the wholesale calculation sub-process 4020. A customer model may include datasets determined based on historical aggregate customer data. For example, a customer model 4005 may have customers with x % being prime, and y % being subprime. Each customer model 4005 may be used to determine the most optimal types of vehicles to acquire and sell at the most optimal timing. For example, if a Retailer deals with used cars, the Retailer will prefer a certain number of vehicles at X years old in the next few months. The Retailer, which is the Purchaser in this case, must understand whether they are going to be able to turn a profit, and the amount of estimated profit, selling these vehicles to customers fitting customer model 4005.

Other input to the wholesale calculation sub-process 4020 includes depreciation and holding costs, inventory profit mandate, non-customer incentives. An output of the wholesale calculation sub-process 4020 is one or more vehicle offers 4025 which may include information about the vehicle itself as well as wholesale pricing. The wholesale calculation sub-process 4020 considers information such as how much it will cost for a wholesaler to bring the vehicle in, applicable depreciation information, and by when the vehicle should be sold to turn a profit or to avoid a loss. The output, a vehicle offer 4025, includes data items representing an offered wholesale price of the vehicle with no financing options (e.g., cash purchase) and the current worth of the vehicle.

The wholesale calculation sub-process 4020 can take input from a series of semi-autonomous collection of services. For example, all of dealership data can be stored on a PostgreSQL database, for example, with multiple tiered application servers.

Inventory Profit Mandate (IPM), which may be at Inventory Holder are a set of rules specifying how vehicles should be sold at wholesale. For example, for a certain type of vehicles, a certain amount of profit is required based on the IPM.

When the wholesale calculation sub-process 4020 is performed, the vehicle offers 4025 for multiple vehicles may be transmitted to other services or Retailers that have access to the system, either as a user or as part of the administration. The Vehicle offers typically have no financing options, and are for cash purchases by the Retailers, for example. These vehicles may not be necessarily ready for retail to customers yet, for example, used cars might be damaged and need further work or repairs.

A vehicle offer 4025 includes details of the vehicle for sale, including for example, make, model, VIN, colors, and other physical features that are static over time. The vehicle offer may also include price and value related information, such as, price, incentives from manufacturer, damages (if any), estimated repair costs (if any), these are features that may change over time. For example, a vehicle's market value tends to decrease over time (depreciation) but may also go up certain times of the year.

The information for a vehicle offer 4025 may be stored as data items in related tables in a relational database, and when rendered, may be presented as serialized messages. A vehicle offer 4025 may be available for a fixed amount of time and may take into consideration data from other sources, such as, for instance, what is the average price of a similar vehicle at public auction, or based on BlackBook™ data.

In some embodiments, an inventory holder may be a Retailer, or may be teamed with a Retailer. At a dealership, which may be a Retailer, the dealership may not hold inventory, and just search for it and bring it in for a customer (no car lot).

### General Retail Calculations

The next stage in the search optimization process 4000 is the general retail sub-process 4030, which takes vehicle offers 4025 to which a Retailer has access, and augment the vehicle offers 4025 with costs associated with a retail sale, which can involve front-line costs related to bringing the vehicle to a front-line state (including repairs, reconditioning, transportation, and associated costs).

The retailer profit mandate is considered independently to that of the Inventory Holder, as the two may be independent of each other. Other input to the general retail sub-process 4030 may include aggregate customer types, consumer equity estimates, for example the value of a trade-in, and lender programs and models.

A retail profit mandate covers cost recovery and fixed costs, and specifies a profit margin for which a vehicle in the vehicle offer 4025 must meet when being sold to a customer. In some cases, a negative profit margin, that is, a loss may be acceptable.

Lender programs and models include a set of guidelines that financing institutions set out for financing the vehicle in the vehicle offer 4025. The guidelines may include loan term and amortization (e.g., 36 months, 60 months or 84 months), interest rate, and customer requirements (e.g., credit score of at least 600). The guidelines may change from time to time (e.g., monthly), and some may be applied with discretion by the lender. A lender model may indicate a difference between an official lender guideline and how the lender actually applies the guideline, e.g., discrepancy.

In some embodiments, the system may use machine learning to analyze lender programs, for example by analyzing car loans have been approved and the applicable term sheets, to find out how a lender tends to deviate from the term sheets based on certain types of customers or certain times of the year (e.g., end of quarter).

Traditionally, in order to properly structure a vehicle deal for a customer, an understanding of the equity (trade and down payment) provided by the customer is required. In addition, each lender has an extensive set of guidelines under which they choose whether to offer funding, and under what conditions. These guidelines vary based on a customer type (e.g., prime or nonprime), the vehicle being purchased, and change over time. Some guidelines are published, and some must be inferred.

The general retail sub-process 4030 is configured to significantly reduce the size of the potential search space. In order to optimize the search process, the general retail sub-process 4030 is configured to pre-calculate potential deal structures, but this is complicated not only by the fact that at the time of pre-calculation the customer is not known, but that the range of customer attributes, lender behaviors, and equity conditions is large and, in combination, enlarges the search space.

The general retail sub-process 4030 therefore takes an approach whereby instead of searching over exact conditions, a search space is constructed over combinations of representative conditions:
a set of customer aggregate types based on a set of parameters that are most significant to lenders
a set of equity bands representative of the amount of equity (positive or negative) that customers typically bring to a deal
a set of deal conditions that are most critical to lenders
where ambiguities exist in the vehicle information variations that affect the price and ability to obtain financing for the vehicle, a variable, similar in concept to an error bar, is used to represent the degree of each variation affecting the price of, or ease of financing, the vehicle

In constructing the search space, the general retail sub-process 4030 performs a set of reductions:
hard reductions where combinations that fall outside the criteria of viability or acceptability from the perspective of the retailer or lender are eliminated; and
soft reductions that are probabilistic in nature, where although a deal structure is in alignment with a retailer's profit mandate, or within a lender's guidelines, when there is reason to believe that such a deal structure would either not be authorized by the sales manager or the lender, respectively.

The output of the general retail sub-process 4030 is a set of approximate deal structures 4035 for each piece of inventory. Each deal structure includes a final price, a down payment, financing terms, and so on. These are typically retained at the Retailer but may, for some workflows, also be shared with other system entities for aggregated workflows.

At this stage, each vehicle may have a plurality of approximate deal structures 4035 stored in a database. Each of these deal structures 4035 may be associated with a type of customer (e.g., prime, nonprime, high credit store). The deal structures 4035 may be prioritized based on one or more targets or priorities, for example, the priority may be a lowest month payment, a maximum length of loan terms, a minimum total cost of loan, get older vehicles sold as soon as possible, and so on. A ranking of the deal structures 4035 for a particular vehicle may be generated based on a weighting heuristic.

### Customer Related Calculations

The wholesale calculation sub-process 4020 and the general retail sub-process 4030 can be performed in advance of a customer's (direct or indirect) interaction with the system (e.g., a vehicle search interface as presented in FIGS. 5 to 21). The first customer interaction (for financed or leased deals) involves the acquisition of individual customer data 4055. A customer calculation sub-process 4050 and a subsequent vehicle selection sub-process 4060 can take a spectrum of customer inputs representing the individual customer data 4055, which may be between a budget of the customer, to a full credit report or credit pull.

In some embodiments, individual customer data 4055 may include a range of data items, including for example: name, address, monthly income, demographic data, budget, and so on. Individual customer data 4055 may also include specific attributes that are relevant to Lenders, for example, newcomer to Canada, student, or a veteran. Some of the individual customer data 4055 may be retrieved from an existing customer profile.

The individual customer data 4055 may also include a desired vehicle properties such as year, make and model. In some cases, a prime customer may have a specific vehicle in mind, and the prime customer can easily pay for it. In other cases, a nonprime or subprime customer may just want a vehicle they can afford.

The customer calculation sub-process 4050 may be configured to perform equity estimates even when the customer data 4055 does not contain equity information. The customer calculation sub-process 4050 can generate different tiering output 4040 based on different equity scenarios: e.g., a customer with equity of 0, 5000, or −40000.

Lender Programs and Models may include models and data used for segmentation of consumers into multiple categories or tiers based on a given set of factors, including for example, a respective credit worthiness of a customer. The mechanism used to segment consumers into a given category or tier may vary between different Lenders. A simple segmentation model may be based simply on the credit rating of a consumer, e.g., for customers with a credit rating below number A is assigned to category or tier 1, a credit rating between number A and number B would result in assignment to category or tier 2 and a credit rating greater than number B would result in assignment to category or tier 3. However, a typical Lender may take several other factors into account in determining a mechanism to segment customers and may include factors such as: employment income, level of credit usage, historical legal and financial information such a bankruptcies or defaults, total debt, current monthly payments or any other factor they deem necessary to determine credit worthiness.

A Lender segmentation model may typically have between five to twenty different categories or tiers. or may well be over twenty categories or tiers. A given Lender segmentation model may allow for overlaps between categories or tiers, that is, a consumer could be segmented into more than one category or tiers. Nor is Lender segmentation model necessarily complete, it may not be possible to assign a given consumer into one or more categories or tiers based on certain constraints that may exist in the model.

Generally, a Lender will not share the mechanism used to generate the segmentation model with other Stakeholders. They may provide tables to Retailers that help a Retailer determine the most likely categories or tiers for a given consumer. These tables are often referred to as “booking sheets.”

Booking sheets contain additional information about how the Lender may advance credit to a particular consumer. FIG. 43A shows an example Booking Sheet 4300 from a Lender for a first group of customers (e.g., non-prime customers). FIG. 43B shows another example Booking Sheet 4350 from the same Lender for a second group of customers (e.g., non-prime customers). Booking sheets may include information about interest rates, maximum loan duration, maximum amount that may be borrowed, incentives provided to the Retailer for arranging a particular loan. The booking sheet may also use additional data such as the age and condition of a vehicle being financed, whether the vehicle is new or user or any other factor the Lender uses in determining credit worthiness.

This individual customer data 4055 and the Lender Programs and Models data is used in the customer calculation sub-process 4050 to generate a “tiering” output 4040 (which despite the name is not necessarily hierarchical). For example, a tiering output 4040 may include, for each lender, a given customer tier or category associated with a customer described in the individual customer data 4055, and may further include a likelihood of approval by a specific Lender for the customer. The tiering output 4040 may include maximum loan amounts and likely interest rates for the customer described in the individual customer data 4055.

In some embodiments, the customer calculation sub-process 4050 can categorize or tier a customer based on received individual customer data 4055 and one or more lender criteria. The tiering output 4040 may be sent to the vehicle selection sub-process 4060 to generate specific vehicle list 4065.

A data reduction step may be performed by the customer calculation sub-process 4050, resulting in the identification of only those lender programs for which the customer is likely to approved, as well as having an assessment of the probability of such an approval by said lender. This customer calculation sub-process 4050 does not have to be directly linked to any piece of inventory.

The results of the customer calculation sub-process 4050 can remain valid until there is a substantive change of the customer's circumstances, or to the circumstances under which lenders provide funding.

### Trade In Calculations

The customer may have a vehicle that he or she wants to trade in as part of a purchase. In many cases, the trade-in carries negative equity (e.g., the customer owes more than the vehicle is worth) due to either sale shortly after purchase, unfavourable conditions when purchasing the trade-in, or changing market conditions.

While a final trade value is based on researching the history and performing a physical inspection of the vehicle, sufficiently close estimates can typically be made by a trade calculation sub-process 4055 through a combination of information provided by the customer, data collected by third parties, and a Trade Mandate that gives guidance on how a particular dealership would like to position their trades.

It should be noted that the logic used in trade calculations at this stage can be employed, with minor variations, in the first inventory stage when performing the alternate workflow of acquisition of used inventory, including sourcing vehicles from customers other than as part of a regular deal.

### Vehicle Selection

Having completed the prior pre-calculation steps, the vehicle selection sub-process 4060 is performed to generate a specific vehicle list 4065, which may include, based on specific customer query, vehicles according to common search criteria (location, year, make, model, style) but also by financing that is appropriate to the customer, including cash deals.

An interactive search is carried out by the vehicle selection sub-process 4060 by matching the tiering output 4040 and trade calculation 4055 against the set of approximate deal structures 4035 from the general retail calculation sub-process 4030, applying suitable filtering, and ordering the results based on one of a set of predetermined ordering constraints, including but not limited to total cost of ownership, minimal payments, or minimal interest.

The vehicles selected during the vehicle selection sub-process 4060 are still based on approximations due to the inputs of the approximate deal structures 4035. A vehicle in the specific vehicle list 4065 may be associated with multiple approximate deal structures 4035. For example, a vehicle in the specific vehicle list 4065 may have two approximate deal structures: one from lender A and one from lender B.

Each approximate deal structure 4035 associated with a vehicle in the vehicle list 4065 may include estimated payment calls that include information such as interest rate, term of loan and monthly payment amount.

In some embodiments, search space reduction and optimization is performed by the vehicle selection sub-process 4060 in the following manners: instead of searching for the entire set of possible deal structures 4035 across different equity bands, the vehicle selection sub-process 4060 limits or reduces the search space to a set of vehicles having a price that would fall only within a specific equity band for the customer.

As additional individual customer data 4055 is received through the app or web interface, the vehicle selection sub-process 4060 may iteratively refine the set of vehicles in the specific vehicle list 4065 by eliminating approximate deal structures 4035 that are no longer applicable to the customer.

For example, when an individual customer data indicates that a near prime customer has had a bankruptcy in the past, certain lenders may not lend to him. For another example, some lenders will not lend to jobless customers. For yet another example, some lenders will lend to jobless customers that are enrolled in post-secondary institution or have strong assets. For lenders that are no longer applicable, the associated deal structures 4035 may be removed from the specific vehicle list 4065.

### Specific Retail Calculations

Having selected one or more specific vehicles that are of interest to the customer, at this point, the search engine no longer needs to compute results based on an entire universe of vehicles, and therefore are able to redo the calculations for the vehicles of interest, which may be selected by the customer through app or web interface. This is done by retail calculation sub-process 4070 using specific trade data, specific information on customer incentives, specific information on the customer, and across all applicable lender programs. The output from the retail calculation sub-process 4070 is detailed deal structures 4075 which includes details of a set of possible financing options for each selected vehicle.

The set of possible financing options are then fed through a final optimization sub-process 4080 to determine the most suitable financing options 4090 for the selected vehicles according to the criteria in effect. The financing options 4090 may include payment terms, down payment amount, trade in value, and so on.

The final options 4090 may be presented, on a display device, for the customer to view and to proceed to the next step if desired.

FIG. 42 shows an example process 1200 for search space optimization, which may be performed by computing device 4100 shown in FIG. 41.

At block 1210, the system computes a plurality of first data structures, each representative of wholesale pricing terms for each vehicle in a plurality of vehicles based on information from a plurality of sources.

In some embodiments, the information from the plurality of sources is normalized, cleaned and streamlined between multiple sources. The information may include, for example, static features of a vehicle.

At block 1220, the system computes a plurality of second data structures, each representative of an approximate deal structures for each vehicle in the plurality of vehicles based on the wholesale pricing information, a set of customer aggregate types, a set of equity bands, and a retailor profit mandate.

In some embodiments, at block 1220, the system does not take individual customer data into consideration for precomputing the second data structures.

In some embodiments, multiple approximate deal structures may be generated for a specific vehicle, for a single Retailer (for instance, the impact of the equity bands together with the profit mandate is taken into consideration), or when a vehicle is saleable by more than one Retailers.

The second deal structures may be specific to each Retailer.

At block 1230, the system computes a plurality of customer tiers, with each customer tier associated with a credit worthiness category or tier for a specific lender and a likelihood of approval by the lender.

In some embodiments, in an optional block 1235 (not shown), the system may be configured to pre-compute a possible deal structure for each vehicle for each customer tier. At this point, as individual customer data is not yet taken into account for the deal structure, the system may perform pre-processing to generate all potential customer tiers applied to every potential deal to yield one or more new potential deals that include financing information.

At block 1240, the system generates a reduced set of data structures from the plurality of second data structures based at least on the plurality of customer tiers; and may further be based on trade in values in the customer data. In some embodiments, at block 1240, the reduced set of data structures can be based on equity value from trade-in vehicle a customer may put forth, which can be matched to the equity bands in block 1220.

At block 1250, the system generates a plurality of third data structures further reduced from the reduced set of data structures based on customer data, each third data structure representing an approximate deal structure for a vehicle in a reduced vehicle list from the plurality of vehicles. In some embodiments, the plurality of third data structures may be determined based on the customer aggregate types from block 1220 or the customer tiers from block 1230.

In some embodiments, the plurality of third data structures is further reduced from the reduced set of data structures based on a customer's credit score or equity level. For instance, a credit score can be matched with a customer tier and an equity level (which can include any trade in and down payment) from the equity bands.

At block 1260, the system computes financing terms for one or more vehicles from the reduced vehicle list based on one or more customer selections. The financing terms may be presented to the customer on a physical display device of a user device, and the display device may be caused by the system to generate user interface elements prompting the user to select a most optimal vehicle offer and proceed to in-store or remote discussion with the retailer to purchase said vehicle.

The financial terms calculated at block 1260 may be different from the plurality of third data structures generated in block 1250. For example, the system may use an exact amount of equity as opposed to equity band used in block 1250. For another example, the system may use exact credit worthiness information to rule out some of the possible deal structures, for instance if the total debt load of the customer is not acceptable to some Lenders.

In the claims, the word “comprising” is used in its inclusive sense and does not exclude other elements being present. The indefinite articles “a” and “an” before a claim feature do not exclude more than one of the features being present. Each one of the individual features described here may be used in one or more embodiments and is not, by virtue only of being described here, to be construed as essential to all embodiments as defined by the claims.

The discussion herein provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above-described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for search space optimization, the system comprising:
at least one processor;
memory in communication with the at least one processor;
instructions stored in the memory, which when executed at the at least one processor cause the system to:
compute a plurality of first data structures, each representative of wholesale pricing terms for each vehicle in a plurality of vehicles based on information from a plurality of sources;
compute a plurality of second data structures, each representative of an approximate deal structure for each vehicle in the plurality of vehicles based on a set of information;
compute a plurality of customer tiers;
generate a reduced set of data structures from the plurality of second data structures based at least on the plurality of customer tiers;
generate a plurality of third data structures further reduced from the reduced set of data structures, each third data structure representing an approximate deal structure for a vehicle in a reduced vehicle list from the plurality of vehicles; and
compute financing terms for one or more vehicles from the reduced vehicle list based on customer selection.

2. The system of claim 1, wherein the instructions when executed further cause the system to: normalize the information from the plurality of sources.

3. The system of claim 1, wherein the set of information comprises the wholesale pricing information, a set of customer aggregate types, a set of equity bands, and a retailor profit mandate.

4. The system of claim 1, wherein the plurality of third data are generated based on customer data.

5. The system of claim 4, wherein the customer tier is generated based in part on the customer data.

6. The system of claim 5, wherein the reduced set of data structures from the plurality of second data structures are generated based on trade in values in the customer data.

7. The system of claim 6, wherein the plurality of third data structures is further reduced from the reduced set of data structures based on a customer's credit score.

8. The system of claim 6, wherein the plurality of third data structures is further reduced from the reduced set of data structures based on a customer's equity level.

9. The system of claim 1, wherein each of the plurality of customer tier is associated with a lender.

10. The system of claim 9, wherein each of the plurality of customer tier is associated with a likelihood of approval by the lender.

11. A computer-implemented method for search space optimization, the method comprising:
computing a plurality of first data structures, each representative of wholesale pricing terms for each vehicle in a plurality of vehicles based on information from a plurality of sources;
computing a plurality of second data structures, each representative of an approximate deal structure for each vehicle in the plurality of vehicles based on a set of information;
computing a plurality of customer tiers;
generating a reduced set of data structures from the plurality of second data structures based at least on the plurality of customer tiers;
generating a plurality of third data structures further reduced from the reduced set of data structures, each third data structure representing an approximate deal structure for a vehicle in a reduced vehicle list from the plurality of vehicles; and
computing financing terms for one or more vehicles from the reduced vehicle list based on customer selection.

12. The method of claim 11, further comprising normalizing the information from the plurality of sources.

13. The method of claim 11, wherein the set of information comprises the wholesale pricing information, a set of customer aggregate types, a set of equity bands, and a retailor profit mandate.

14. The method of claim 11, wherein the plurality of third data are generated based on customer data.

15. The method of claim 14, wherein the customer tier is generated based in part on the customer data.

16. The method of claim 15, wherein the reduced set of data structures from the plurality of second data structures are generated based on trade in values in the customer data.

17. The method of claim 16, wherein the plurality of third data structures is further reduced from the reduced set of data structures based on a customer's credit score.

18. The method of claim 16, wherein the plurality of third data structures is further reduced from the reduced set of data structures based on a customer's equity level.

19. The method of claim 17, wherein each of the plurality of customer tier is associated with a lender.

20. The method of claim 19, wherein each of the plurality of customer tier is associated with a likelihood of approval by the lender.
